(19) United States
(12) Patent Application Publication
(10) Pub. No.: US 2024/0367845 A1
(43) Pub. Date: Nov. 7, 2024

(54) Plastic container with flattened supporting feet and blow molding device

(71) Applicant: KRONES AG, Neutraubling (DE)

(72) Inventors: Peter KNAPP, Schmatzhausen (DE); Bastian TISSMER, Regensburg (DE)

(21) Appl. No.: 18/639,610

(22) Filed: Apr. 18, 2024

(30) Foreign Application Priority Data
Apr. 18, 2023 (DE) 10 2023 109 675.3

(51) Int. Cl. B65D 1/02; B29C 49/48; B29C 49/62; B29L 31/00; B65D 1/40

(52) U.S. Cl. CPC B65D 1/0284; B29C 49/48; B29C 49/62; B65D 1/40; B29C 2049/4882; B29C 2049/622; B29L 2031/7158

(57) ABSTRACT

Plastic container for beverages has a bottom region, a main body and a mouth. The bottom region has at least three supporting feet, wherein each of these supporting feet has at least one supporting region extending in the circumferential direction with respect to the longitudinal direction over a supporting region circumferential angle and each having at least one substantially flat, supporting surface for standing the plastic container upright, wherein at least one groove having a groove base acting as a tension band is arranged between two adjacent supporting feet. The groove base widens outwardly in the radial direction of the plastic container, wherein the at least three supporting feet are delimited in the circumferential direction by at least one foot side region in each case and in a radial direction toward the outside by a foot outer region.

### BACKGROUND OF THE INVENTION

The present invention relates to a plastic container—preferably a PET plastic container—and/or to a plastic bottle. In particular, the present invention relates to a plastic container for beverages. In addition, the invention is also directed towards a bottom structure for such a plastic container. In the prior art, plastic containers are usually produced by blow molding processes and, in particular, stretch blow molding processes. For this purpose, heated plastic preforms in particular are expanded inside blow molds to form plastic containers or plastic bottles.

So-called petaloid bottle bottoms are known from the prior art. Containers with a petaloid bottle base have a plurality of supporting feet, and often five supporting feet. For example, the container bottoms bear the weight of the filled bottles and are therefore subject to relatively high loads. It is known from the prior art that grooves run between such supporting feet.

For the design of PET-petaloid bottle bottoms in hot locales, a so-called tension band is used in the prior art, for which the use of a rotated surface as a tension band between the (supporting) feet is known from the prior art, which collects more material to keep the bottom center in position, similarly to a “safety belt,” even under internal pressure and temperature effects.

DE 10 2013 110 139 A1 describes a plastic container with a petaloid bottom, in which, between two adjacent supporting feet, a tension band is designed as a groove base, which is outwardly bulged and has a constant curvature when viewed in the circumferential direction. The bottom wall of the container is thus outwardly bulged—in particular, in the region of a groove base and in particular in the region of a geometric nut of the groove base—comparable to a region of a spherical surface. It is also described that the tension band surface is created by a rotation about an axis of rotation.

In order to produce plastic containers with such a petaloid bottom, the plastics preforms are subjected to a blowing air (and/or fluid blowing medium) under a (final) blowing pressure of over 20 bar. A disadvantage is that a comparatively high pressure of the blowing air is required during production for forming the container, which is reflected in the production costs.

The final blowing pressure, i.e. the pressure at which the plastics preform is completely formed, represents a significant proportion of the energy required for the blow molding process, such that it should be as low as possible. In particular, the formation of the last corners of the container, in particular in the corner regions of the supporting feet, for example, of a petaloid bottom, is decisive for the level of the final blowing pressure.

The object of the present invention is to overcome the disadvantages known from the prior art and to provide a plastic container and a blow molding device for producing these plastic containers, which permit energy-efficient production, so that the production costs of the container and thus also the energy costs can be reduced. At the same time, it is an object to achieve a high level of bottom stability of the container and to offer a distribution of the plastics material that is as optimal as possible during the production of the plastic container (for example, in a stretch blow molding method in which a plastics preform by means of applying fluid medium to a blow mold, which has a bottom mold).

### SUMMARY OF THE INVENTION

A plastic container according to the invention—in particular, for beverages—has a bottom region, a main body adjoining the bottom region in the longitudinal direction of the plastic container, and a mouth region with a container mouth adjoining the main body at least indirectly in the longitudinal direction.

The bottom region has at least three supporting feet—preferably at least five and particularly preferably exactly five supporting feet. The bottom region is preferably designed as a petaloid bottom.

The longitudinal direction is in particular a direction along a central axis of the plastic container. The central axis of the plastic container extends in particular (centrally) through the (opening of the) container mouth (and also, in particular, centrally through a bottom region of the container and/or through a bottom center of the bottom region—in particular, through an injection point). In the (upright) standing position of the container, the central axis extends in particular parallel to a vertical direction. The longitudinal direction preferably runs from a bottom region (along the central axis) in the direction of the mouth region of the plastic container.

A circumferential direction is preferably understood as a direction of rotation about the central axis (selected as the axis of rotation) (or longitudinal direction) of the container.

In the following, a radial direction (with respect to the longitudinal direction and/or the central axis) is understood as a direction with respect to the longitudinal direction (or the central axis of the container) that is perpendicular to the longitudinal direction (or the central axis) and that, in particular, moves away (in a rectilinear manner and, in particular, in a direction perpendicular to the central axis) from the longitudinal direction (or the central axis).

Each of these (at least three) supporting feet has at least one supporting region extending in the circumferential direction with respect to the longitudinal direction over a supporting region circumferential angle (and in the radial direction with respect to the longitudinal direction), each having at least one, in particular substantially flat, supporting surface for standing the plastic container upright. In other words, the supporting surface of a supporting foot forms the contact surface of the supporting foot between the supporting foot and the supporting plane in the state in which it stands (upright or on its bottom region or on its at least three supporting feet) on a supporting plane.

The supporting region circumferential angle is preferably selected from an angular range between 5° and 15°, preferably between 7° and 12°, and particularly preferably between 8° and 10°, and particularly preferably substantially 9°.

The supporting surface preferably extends over the entire supporting region circumferential angle. The supporting region preferably extends from the bottom center (in particular the injection point) to the main body. The supporting region preferably extends substantially along its complete radial extension over the substantially complete supporting region circumferential angle. In other words, the supporting region extends at any distance from the central axis over virtually the same angle, the supporting region circumferential angle. Preferably, the supporting region is designed or configured substantially identically (at least one main extension surface of the supporting region) viewed in the circumferential direction.

Each supporting foot preferably has exactly one supporting surface. The supporting surface (in each case) is preferably designed in the shape of a circular ring segment.

The circumferential angle is preferably understood as an angle in the circumferential direction about the central axis according to a projection in a plane perpendicular to the central axis. In particular, the supporting region circumference over which the supporting region extends is measured (as an angle in the circumferential direction about the central axis) at the projection of the supporting region in a plane perpendicular to the longitudinal axis.

In this case, at least one groove having a groove base-preferably acting as a tension band (in particular between a bottom center, for example, an injection point, of the bottom region and the main body)—is arranged between (in particular in each case) two, in particular adjacent, of these supporting feet. The groove base preferably widens outwardly in the radial direction of the plastic container. The widening preferably takes place (preferably continuously and particularly preferably linearly) with increasing distance from the central axis and/or from the bottom center. Widening is understood in particular to mean that a width of the groove base (wherein a width is understood to mean an expansion in the circumferential direction) increases outwardly in size in a radial direction of the container.

It is also conceivable that the groove base (in particular starting from a predetermined distance from the central axis) has in particular substantially) the same width, i.e. in particular (wherein width is understood to mean an extension in the circumferential direction). Thus, for example, with the exception of an initial region of the groove base in which the groove base (still), in particular continuously and/or consistently, widens, the width of the groove base or the extension of the groove base in the circumferential direction can remain (substantially) constant, in particular over the entire remaining region of the groove base and/or over the entire remaining region of the groove base with the exception of an end portion, after the predetermined distance has been reached. Preferably, the predetermined distance from the central axis is (substantially) equal for at least two, preferably for at least three, for at least four and particularly preferably for all groove bases.

The groove base preferably extends in the circumferential direction over a (predetermined) groove base circumferential angle. Thereby, the groove base acts as a tension band. Preferably, the groove base (substantially completely and preferably completely) forms the tension band. In particular, the groove base is designed over the (predetermined) circumferential angle (in particular, by its shape) in such a way that it acts as a tension band or is suitable for acting as a tension band. Preferably, the groove base substantially follows a hemispherical and/or an ellipsoidal progression. Progressions approximated to the geometry of a sphere (or hemisphere) offer the advantage of a particularly stable transmission of forces from the bottom center to the main body in order to distribute the weight force (of the fill substance) acting on the bottom center (which does not contact the supporting plane in the state in which the plastic container is standing upright on a supporting plane) to the container wall (in particular of the main body).

Preferably, the bottom center (in particular the injection point, which preferably forms the bottom center) does not contact the supporting plane in the state in which the plastic container is standing upright on a supporting plane, but is spaced apart from the flat supporting surface—by what is known as the bottom clearance. Preferably, only the (supporting surfaces of the supporting regions of the) supporting feet touch the supporting plane.

Furthermore, the container is preferably designed in one piece.

In particular, the groove base circumferential angle over which the groove base extends is measured (as an angle in the circumferential direction about the central axis) at the projection of the groove base in a plane perpendicular to the longitudinal axis.

The at least three supporting feet (in each case) are delimited in the circumferential direction (and against the circumferential direction) by at least one foot side region in each case and in a radial direction toward the outside by a foot outer region.

In other words, at (substantially) every point of the foot outer region, the main direction of extension of a normal vector is directed in the radial direction (but not in or against the circumferential direction and/or in or against the longitudinal direction).

In particular, the main direction of extension of the normal vector is understood to be that direction selected from the directions (in or against) the circumferential direction, (in or against) the radial direction, and (in or against) the longitudinal direction in which the component of the normal vector is greatest. This applies in particular to a foot outer region forming the main shape of the supporting foot, which, furthermore, can additionally have decorative elements, such as depressions and/or elevations and/or grooves (but preferably does not have any further elements, but rather is substantially smooth).

Preferably, at (substantially) every point of the foot side region, the main direction of extension of a normal vector is directed in (or against) the circumferential direction (but not in or against the radial direction and/or in or against the longitudinal direction).

Preferably, at (substantially) every point of the supporting surface of the supporting region, the main direction of extension of a normal vector is directed in or against the longitudinal direction (but not in or against the radial direction and/or in or against the circumferential direction).

The foot outer region preferably adjoins the supporting region and/or preferably overlaps in regions with the supporting region, namely in the region in which the main direction of extension of the normal vector of the supporting region points in the radial direction. The supporting region also has in particular regions in which the normal vector of each point of the supporting region has a main direction of extension in the radial direction.

The foot outer region is preferably designed (at least in portions) in the manner and/or similar to a region of a lateral surface of a cylinder. The foot side region, on the other hand, extends only within a very narrow angular segment and extends over almost the complete (maximum) radial extension of the plastic container and/or extends (substantially or almost) from the bottom center to (almost) a maximum radial extension of the bottom region at the same height with respect to the longitudinal direction.

In other words, the main directions of extension of the foot side region are the radial direction and the longitudinal direction. In other words, the main directions of extension of the foot outer region are the circumferential direction and the longitudinal direction. The main directions of extension of the supporting surface are preferably in the circumferential direction and in the radial direction.

According to the invention, the at least three supporting feet, preferably the at least five supporting feet, in a corner region of the supporting feet, in which the supporting region, the foot side region and the foot outer region meet, have (in each case) at least one flattened region which causes a flattening of the corresponding supporting foot in the corner region. In particular, the corner region is arranged between the supporting region (and/or the supporting surface), the foot side region and the foot outer region.

The invention is described below (usually) with respect to a supporting foot and (at least) an adjoining and/or adjacent groove (and its groove base). All further supporting feet of the at least three and/or the at least five supporting feet and preferably all further supporting feet of the bottom region are preferably designed in the same way. All the supporting feet and/or each groove and/or each groove base are preferably designed identically.

A flattening is preferably to be understood such that this region has a less pronounced bulge or curvature than an adjacent region. In particular, the corner region having the flattened region deviates from a sphere (segment) shape. The flattened region is preferably arranged substantially in the middle and/or centrally in the corner region.

The flattened region preferably has a curved and/or bulged outer surface. The (substantially) entire flattened region and/or corner region (in particular in each case in both main directions of curvature) is preferably outwardly bulged and/or convex.

“Outwardly bulged” is to be understood in particular to mean that the wall of the container is bulged in the corresponding region towards the outside of the container. “Outwardly bulged” is to be understood in particular to mean that the container wall, in particular the outer surface of the container, is convex in the corresponding region (wherein “convex” in particular means that an even distance between any selectable points of this surface (of this region) runs completely in the container interior (in particular completely in the interior of the bottom region) and/or not outside of the container).

The foot side region of the supporting foot and/or the corner region and/or the flattened region is preferably not inwardly bulged. The corner region and/or the flattened region are preferably contiguous regions.

Accordingly, “inwardly bulged” is to be understood in particular to mean that the wall of the container is bulged in the corresponding region towards the container interior (meaning, for example, towards the bottle interior). “Inwardly bulged” is to be understood in particular to mean that the container wall, in particular the outer surface of the container, is concave in the corresponding region (wherein “concave” in this case means in particular that an even distance between any selectable points of this surface or this region runs completely outside of the container wall and/or completely outside of the container and/or not in the container interior).

A region of the container bottom that is convexly curved in both main directions of curvature is understood in particular to mean that, at any point of the region, the tangential plane runs or is arranged outside of the container and/or not in the container interior at least in the tangential plane region surrounding the point.

A region of the container bottom that is concavely curved in both main directions of curvature is understood in particular to mean that, at any point of the region, the tangential plane runs or is arranged not in the container interior and/or (completely) outside of the container at least in the tangential plane region surrounding the point.

In particular, the corner region represents a transition region between the supporting region (and/or the supporting surface), the foot side region and the foot outer region. The flattening causes in particular that a transition between the supporting region and the foot side region, between the supporting region and the foot outer region and/or between the foot side region and the supporting region (and/or the supporting surface) do not meet one another at substantially one corner point.

In other words, by providing a flattened region (and the flattening of the corner region), it is achieved that the container bottom is arranged in this region closer to the tension band or groove base and/or is better reached by it during the blow molding process of the plastics preform. The flattened region offers the substantial advantage that a significantly lower blowing pressure is required for forming the corner region or the supporting feet.

In complex tests, the applicant has determined by comparison with a bottom region of the embodiment without a flattened region, for example, the bottom region of the applicant described in the patent application DE 10 2013 110 139 A1, that, due to the flattening, a significantly lower blowing pressure is required for producing a plastic container that is uniformly formed in all regions. In particular, the corresponding corner regions or the outer regions of the supporting feet are formed well (by providing the flattened region) even at lower blowing pressure.

This offers the advantage of significantly more energy-saving production of the plastic container.

Looking at a region of the foot which is referred to as a foot lower region and which limits the supporting foot against the longitudinal direction and/or in which the main direction of extension of the normal vector points against the longitudinal direction, an edge region between the foot lower region and the foot outer region, an edge region between the foot outer region and the foot side region and an edge region between the foot side region and the foot lower region can be defined. In the edge regions, the components of the normal vector are the same in two directions in each case. For example, in the case of an edge region between the foot outer region and the foot side region, the components of the normal vector are the same in the radial direction and in the circumferential direction. The edge regions therefore preferably represent transition regions in which, for example, the substantially (radially) outwardly facing foot outer region merges into the foot side region facing substantially in the circumferential direction.

The edge region between the foot outer region and the foot side region forms, and within which in particular the components of the normal vector are the same in the radial direction and in the circumferential direction, preferably opens into the flattened region at a different mouth region than the edge region between the foot outer region and the foot lower region and preferably opens into the flattened region at a different mouth region than the edge region between the foot side region and the foot lower region. The edge region between the foot lower region and the foot side region preferably opens into the flattened region in a different mouth region than the edge region between the foot side region and the foot outer region.

In other words, the edge regions do not meet one another. Preferably, two edge regions (also) do not meet in each case (but each open into the flattened region).

Preferably, the three edge regions do not meet (not even as continued lines) at one point. Preferably, the three mouth regions are spaced apart from one another and lie in particular at an edge of the flattened region. Preferably, the three mouth regions are in each case spaced apart in pairs by at least one third of the, preferably by at least half of the, preferably substantially by the, preferably by twice the (in particular maximum) extension of the supporting surface in the circumferential direction. The distances are preferably different from one another. It is thereby achieved that the bottom region is already closer to the groove base in the region of the flattened region, whereby the forming is advantageously facilitated.

As a result, a reduction of the final blowing pressure between 3 to 5 bar is advantageously possible compared to the required final blowing pressure for bottom molds without flattened regions.

Preferably, a region of maximum curvature of the corner region and/or the supporting foot is not within the flattened region in at least one predetermined direction of curvature and preferably in two predetermined directions of curvature. Preferably, a region of minimum curvature of the corner region and/or the foot side region lies within the flattened region.

Preferably, viewed in the radial direction, the flattened region is not arranged between the central axis and the supporting surface (but rather, viewed in the radial direction, further outward than the supporting surface and/or at the same radial distance from the central axis as the supporting surface). Preferably, the (preferably each) flattened region is spaced apart from the central axis by at least 60%, preferably by at least 70% and/or by at least 80%, of the bottom and/or container radius (half the container diameter, for example, of the main body). Additionally or alternatively, the flattened region is spaced from the central axis by at most 90%, preferably by at most 80% and/or by at most 70%, of the bottom and/or container radius (half the container diameter, for example, of the main body).

Preferably, the (preferably each), in particular complete, flattened region encloses a circumferential angle of at most 30°, preferably at most 25°, and particularly preferably at most 22° with the geometric center of the supporting region and/or the supporting foot. An angular segment of the bottom region, which has a minimum circumferential angle of 2.5°, preferably 3°, preferably 5°, is preferably arranged between the geometric center of the supporting region and/or of the supporting foot (in which the flattened region is also not arranged in portions). Particularly preferably, this circumferential angles applies to a bottom region having 5 supporting feet.

The present invention is further directed to a plastic container—in particular, for beverages—with a bottom region, a main body adjoining the bottom region in the longitudinal direction of the plastic container, and a mouth region adjoining the main body at least indirectly in the longitudinal direction and having a container mouth.

In this case, the bottom region has at least three supporting feet, which preferably each extend over a supporting foot circumferential angle viewed in the circumferential direction (in particular with respect to a central axis of the bottom region extending along the longitudinal direction, preferably a circumferential direction as defined above).

In this case, each of these supporting feet has at least one supporting region extending in the circumferential direction over a supporting region circumferential angle (and in a radial direction with respect to the longitudinal direction and/or central axis, radial direction preferably defined as described above) and having preferably in each case at least one, in particular substantially flat, supporting surface for standing the plastic container upright. In particular, the bottom region of a supporting foot, which contacts the supporting plane when the plastic container is standing upright on a supporting plane (in particular in a completely filled state), forms the supporting surface.

For example, particularly preferably in the case of five supporting feet, the supporting region circumferential angle can be less than 20°, preferably less than 15°, preferably less than 10°, and particularly preferably substantially 9°.

The supporting region preferably extends (particularly preferably substantially exclusively) in an angular segment (given by the supporting region circumferential angle) (with respect to the circumferential direction) in which the supporting surface of the supporting foot extends. In other words, the (angular) extension viewed in the circumferential direction can define the supporting region. In other words, the supporting region in the angular segment of the bottom region given by the supporting region circumferential angle takes up substantially the entire bottom region lying in this angular segment. The supporting region preferably takes up at least 50%, preferably at least 70%, and particularly preferably at least 90% of the bottom region lying in the angular segment.

In this case, at least one groove having a groove base, preferably acting as a tension band (between a base center of the bottom region and the main body), is arranged (preferably in pairs) between (in each case) two, in particular adjacent, of said supporting feet. Preferably, the groove base widens outwardly in the radial direction. The widening preferably takes place (preferably continuously and particularly preferably linearly) with increasing distance from the central axis and/or from the bottom center. Widening is understood in particular to mean that a width of the groove base (wherein a width is understood to mean an expansion in the circumferential direction) increases outwardly in size in a radial direction of the container.

Preferably, the at least three supporting feet are each bounded in the circumferential direction (as well as against the circumferential direction) by at least one foot side region. Preferably, the at least three supporting feet are each bounded in a radial direction toward the outside by a foot outer region.

A turning point region is thereby arranged between the supporting foot and an adjacent groove, in which turning point region an orientation of a curvature of the bottom region changes (preferably reverses) and, in particular, is transferred or merges from a convex curvature into a concave curvature. Preferably, a region of the supporting foot facing the groove is convexly curved or bulged outwardly and a region facing the supporting foot is concavely curved or bulged inwardly (in a direction of curvature).

Preferably, the groove is designed to be saddle-shaped at least in a region facing the turning point region or in a region facing or adjacent to and/or adjoining the supporting foot (particularly preferably over the almost complete region adjoining the turning point region).

The groove, particularly preferably with the exception of the groove base), is preferably designed to be saddle-shaped or anticlassically curved over substantially its substantially complete surface (i.e. that the surface of the groove is curved oppositely in the two main directions of curvature). Preferably, complete surface means at least 70%, preferably at least 80%, preferably at least 90% and particularly preferably at least 95% of the surface area of the groove. Here, a groove is preferably understood to mean the bottom region which results from the bottom center up to the main body over the angular segment defined by the groove circumferential angle.

Preferably, the region of the supporting foot and/or of the foot side region facing the groove or adjacent thereto is convexly curved or bulged outwardly along a main direction of curvature and is not concavely curved and preferably convexly curved along the second main direction of curvature.

Preferably, a longitudinal sectional contour resulting from a longitudinal section through the (preferably through each) groove, and preferably through the groove base of the groove, of the plastic container, which longitudinal section is taken along a longitudinal sectional plane that runs through the central axis of the container, is convexly curved.

The turning point region preferably extends/extend over at least 75%, preferably at least 80%, and particularly preferably at least 90% of the arc length of a line originating from the injection point and/or the base center and formed from there in an (exclusively) radial direction toward the bottom wall outwardly to the main body.

Preferably, a convex curvature of the supporting foot merges into a concave curvature of the groove in the turning point region.

Preferably, the (in particular entire) turning point region (between the groove and the adjacent supporting foot, in particular substantially from the base center to the main body) is arranged in each case substantially within one angular segment, which is in particular comparatively narrow compared to the supporting foot circumferential angle and/or groove circumferential angle and which is provided by the turning point circumferential angle. The turning point circumferential angle can be smaller than one third, preferably smaller than one quarter, preferably smaller than one fifth, and particularly preferably smaller than one eighth of the groove circumferential angle and/or the supporting foot circumferential angle.

The turning point circumferential angle is preferably less than 5°, preferably less than 3°, preferably less than 2°, preferably substantially 1° and particularly preferably less than 1°. An angular segment over which the turning point region extends and/or within which the turning point region is arranged is preferably defined by this turning point circumferential angle.

For example, the turning point region can extend in a predetermined angular segment—which is preferably given by the turning point circumferential angle—over more than 50%, preferably more than 65%, preferably more than 70%, and particularly preferably more than 80% and particularly preferably more than 90% of the bottom region from the bottom center to the main body (in this case, the percentage specifications relate in particular to a bottom curve that follows the bottom region and runs along a fixed predetermined circumferential angle with respect to the circumferential direction). The turning point region preferably extends up to and/or almost up to the main body.

In other words, a (maximum) extension of the turning point region, viewed in the radial direction, is a multiple, preferably 20 times, preferably 10 times, preferably at least 5 times greater than a (maximum) extension in the circumferential direction. In particular, the turning point region is a transition region (substantially) delimiting the foot side region and/or the groove (substantially) completely from one another, in which the curvature of the surface of the bottom region reverses at least along a corresponding main direction of curvature.

Preferably, the supporting foot circumferential angle, particularly preferably in the case of a container having exactly five supporting feet, is smaller than 60°, preferably smaller than 50°, preferably smaller than 40°, and particularly preferably 38°, 36°, or 34°. The supporting foot preferably extends within an angular segment of the bottom region given by the supporting foot circumferential angle. Preferably, the extension of the supporting foot, viewed in the circumferential direction, increases in the radial direction corresponding to the angular segment given by the supporting foot circumferential angle. The supporting foot preferably extends over the entire supporting foot circumferential angle along its entire radial extension.

The extension of the supporting foot (viewed in the circumferential direction) over a supporting foot circumferential angle extends from a foot side region (over an edge region) over the supporting region (for example, the supporting surface) and/or the foot lower region and over a further foot side region.

According to the invention, each of the at least three supporting feet has at least one (viewed in the circumferential direction), preferably at least partially and particularly preferably (in particular exclusively viewed in the circumferential direction) completely flattened region arranged between the supporting region and the adjacent groove, and at least one bulged region arranged between the flattened region and the supporting region (viewed in the circumferential direction), wherein the flattened region is preferably flattened compared to the bulged region with respect to a curvature behavior.

In this case, the bulged region extends, viewed in the circumferential direction, at most over half the supporting region circumferential angle (preferably over at most 0.45 of the supporting region circumferential angle and particularly preferably over 0.4 of the supporting region circumferential angle) and/or at most over one tenth of the supporting foot circumferential angle (of the corresponding supporting foot).

In other words, it is proposed that within a comparatively narrow angular segment, namely within half a supporting region circumferential angle and/or within a ⅛, preferably within 1/9 and particularly preferably one tenth of the supporting foot circumferential angle (of the corresponding supporting foot), a bulged region is provided which merges into a comparatively less strongly curved and/or flatter region, the flattened region, in the direction of the groove base.

Preferably, an end of the bulged region facing away from the supporting region—viewed in the circumferential direction—encloses with the supporting region an angle of at most half a supporting region circumferential angle and/or an angle of at most one (⅛, preferably 1/9, particularly preferably one) tenth of the supporting foot circumferential angle. This offers the advantage that the bulged region, viewed in the circumferential direction, is arranged very close to the supporting region.

In other words, viewed in the circumferential direction, the bulged region extends, measured from the supporting region, not beyond an angular range which corresponds at most to half the supporting region circumferential angle and/or one tenth of the supporting foot circumferential angle.

A flattening of the flattened region compared to the bulged region with respect to a curvature behavior can be understood in particular to mean that a curvature progression, viewed in the flattened region, of the bottom region assumes a local minimum in the flattened region and assumes a local minimum and at least one (local) and preferably a global (with respect to the flattened region and the bulged region and preferably with respect to the entire supporting foot) maximum in the bulged region. In other words, a region of maximum curvature values is arranged in the bulged region, whereas minimum curvature values and/or at least no locally and/or globally maximum curvature values with respect to the flattened region and the bulged region are preferably assumed in the flattened region.

In the curvature progression known from the prior art, a curvature or bulging of the supporting foot in the direction of the groove base only assumes a maximum curvature value within a larger circumferential angle range and then merges into a flatter region with less great curvature only later (i.e. at a greater distance or angle relative to the supporting region viewed in the circumferential direction).

The solution proposed according to the invention offers the advantage that the flattened region, which lies in the critical region with regard to good ability to be formed during the blow molding process, can be shaped significantly better due to its flattening (i.e. less pronounced bulging or smaller curvature). In contrast, a bulged region which is comparatively difficult to form due to the strong curvature or bulging can be formed significantly better due to its proximity to the supporting region, so that overall better ability to be formed is achieved.

Preferably, particularly preferably in the case of (exactly) 5 supporting feet, the bulged region (viewed in the circumferential direction) extends over a maximum circumferential angle of 8°, preferably at most 5°, preferably at most 4°, and particularly preferably substantially 3.5°.

The bulged region preferably adjoins the supporting region. The bulged region preferably adjoins the supporting surface of the supporting region. The bulged region is preferably located between the supporting region and the flattened region. In this way, it is achieved that a bulged region which is more strongly curved compared to the flattened region is arranged between the supporting region and the flattened region, which is comparatively less strongly curved. This bulged region ensures that, in the immediate vicinity of the supporting region or the supporting surface, an in particular strong curvature is introduced in the direction of the groove base, so that a considered (in particular as desired) portion of the flattened region, viewed in the longitudinal direction, is already spaced significantly less far away from the groove base than the supporting surface and/or a region of the supporting region of the same distance from the central axis as the considered portion of the flattened region.

The plastic container (also referred to below as container) can thereby have any above in connection with the above-described plastic container, individually or in combination with one another. Conversely, the above-described plastic container can have any described feature (in particular also described below), individually or in combination with one another. In particular, identically selected terms such as circumferential direction, central axis, longitudinal direction, radial direction, convex, concave, inward bulge and the like are defined in the same way. Identically termed regions (such as, for example, flattened region, bulged region, supporting region, . . . and the like) of the container or elements/features preferably denote the same regions of the containers or elements/features of the containers.

The bulged region and the flattened region are preferably part of the corner region, described above, of a supporting foot. Preferably—considered in the circumferential direction—a further bulged region is provided between the flattened region and the groove adjacent thereto and also adjoins the flattened region. Preferably, the further bulged region—considered in the circumferential direction—is arranged between the flattened region and the turning point region. The further bulged region preferably adjoins both the flattened region and the turning point region.

Preferably, the bulged region, and particularly preferably also the further bulged region, is not concavely and preferably convexly curved in both main directions of curvature.

The flattened region is preferably not concavely and preferably convexly curved in both main directions of curvature (across the entire region). In this case, the flattened region can be not curved, i.e. flat, in at least one direction or in both directions.

Preferably, the surface curvature of the bulged region is greater in regions, particularly preferably for any point of the bulged region, than the surface curvature of any point of the flattened region.

A flattening of the flattened region compared to the bulged region with respect to a curvature behavior can in particular also be defined by means of so-called bottom lines. A bottom line is a (hypothetical) line that is formed along (the outer surface of) the bottom region and that always maintains or takes up the same distance from the central axis (which in particular runs through the bottom center).

The bottom line is preferably formed as a cylindrical section contour from a cylinder section with the bottom region, wherein the central axis of the cylinder runs along the central axis of the plastic container.

If this bottom line is unwound (along the cylinder lateral surface) and a curvature progression of this unwound bottom line is considered, the curvature progression within the portion of the bottom line corresponding to the supporting foot, preferably in the bulged region, assumes maximum curvature (amount) values or a local and preferably global maximum. If one considers the bottom line portion starting from the supporting region of a supporting foot up to the adjacent groove and/or up to the turning region to the adjacent groove, the curvature progression in the bulged region, which is arranged between the supporting region and the flattened region, assumes maximum values of the amount of curvature. The amounts of the curvature values assumed within the bottom line portion corresponding to the flattened region are all smaller than the amounts of the curvature values assumed and corresponding to the bulged progression.

The present invention is further directed to a plastic container—in particular, for beverages—which has a bottom region, a main body adjoining the bottom region in the longitudinal direction of the plastic container, and a mouth region adjoining the main body at least indirectly in the longitudinal direction and having a container mouth, wherein the bottom region has at least three supporting feet.

In this case, each of these supporting feet has at least one supporting region extending in the circumferential direction with respect to a central axis of the bottom region extending along the longitudinal direction over a supporting region circumferential angle (and in the radial direction with respect to the longitudinal direction/central axis), each having at least one, in particular substantially flat, supporting surface for standing the plastic container upright, wherein between (in each case) two, in particular adjacent, of these supporting feet at least one groove is arranged with a groove base acting in particular as a tension band (between a bottom center of the bottom region and the main body).

The groove base preferably widens outwardly in the radial direction. The widening preferably takes place (preferably continuously and particularly preferably linearly) with increasing distance from the central axis and/or from the bottom center. Widening is understood in particular to mean that a width of the groove base (wherein a width is understood to mean an expansion in the circumferential direction) increases outwardly in size in a radial direction of the container.

According to the invention, the bottom region is designed in such a way that a bottom line running along the bottom region from a geometric center of the supporting region of a supporting foot to the groove base of the adjacent groove, at a constant distance from the central axis, has a geometric progression of height values considered along the central axis as a function of an angle of rotation measured in the circumferential direction with respect to the geometric center of the supporting region, which angle of rotation, after passing through the supporting region (from the supporting region in the direction of the adjacent groove), decreases sharply in such a way that a maximum height value assumed in the supporting region within a line portion (of the bottom line), which takes up at most 30% of an angle of rotation between the geometric center of the supporting region and the geometric center of the groove base of the adjacent groove, is reduced by at least 8%, preferably at least 10%, preferably at least 12%, and particularly preferably by at least 14% with respect to a maximum height difference of the bottom line.

This offers the advantage that corner regions of the supporting foot, which are shaped only late in the blow molding process, are brought closer to the groove base. A significantly improved ability to be formed can thereby be achieved. This offers the advantage of more energy-efficient production of a plastic container.

The bottom line can be formed (as described above) by a cylinder section with the bottom region, in particular by a flattened region and/or bulged region as described above. The bottom line can then be unwound (along the cylinder lateral surface) in order to obtain a progression of height values (height progression) as a function of a circumferential angle (which is preferably measured with the position of the geometric center of the supporting region as a reference position). The height values describe a coordinate of the corresponding point with respect to the central axis. The height values are in this case considered in the opposite direction as the longitudinal direction (that is to say in a height direction which is oriented opposite to the longitudinal direction and runs parallel thereto), i.e. the supporting surface of the supporting region assumes a greater height value than the bottom center and/or a groove base. The groove base preferably assumes a minimum height value of a (each) bottom line. The supporting region of the supporting foot preferably assumes a maximum height value of a (each) bottom line.

The plastic container (also referred to below as container) can thereby have any above in connection with the two above-described plastic containers, individually or in combination with one another (also combinations of the features of the two plastic containers described above). Conversely, each of the two plastic containers described above can have each feature described (in particular also below) individually or in combination with one another (also in combination with features of the respective other plastic container described above). In particular, identically selected terms such as circumferential direction, central axis, longitudinal direction, radial direction, convex, concave, inward bulge and the like are defined in the same way. Identically termed regions (such as, for example, flattened region, bulged region, supporting region, . . . and the like) of the container or elements/features preferably denote the same regions of the containers or elements/features of the containers.

The bottom line is preferably selected such that it runs through the corner region described above and/or the bulged region described above and/or the flattening progression described above. A point of the bottom line which takes up 30% of an angle of rotation between the geometric center of the supporting region and the geometric center of the groove base of the adjacent groove is preferably located within the flattened region described above.

The above-described progression of the height values of a bottom line (in particular its proportional reduction of the height values) preferably applies to any bottom line which takes up a predetermined distance from the central axis, which distance lies between two predetermined distance values which differ from one another. The two predetermined distance values are preferably greater than the radius of a pitch circle of the container. The pitch circle is in particular the circular ring, on which the supporting surfaces (designed in the manner of a segment of a circle) of the supporting feet are arranged.

In a preferred embodiment, the bottom region is designed in such a way that a bottom line running along the bottom region from a geometric center of the supporting region of a supporting foot over a turning point region, in which an orientation of the curvature of the bottom region (such as a bottom line mentioned below) changes, to the groove base of the adjacent groove at a constant distance from the central axis has a geometric progression of height values, considered along the central axis, as a function of an angle of rotation measured in the circumferential direction with respect to the geometric center of the supporting region, which angle of rotation decreases strongly in a region adjoining the supporting region such that a maximum height value assumed in the supporting region within a line portion of the bottom line, which line portion takes up at least 30% of an angle of rotation between the geometric center of the supporting region and the geometric center of the groove base of the adjacent groove, is reduced by at least 15%, preferably at least 20%, preferably at least 25% and particularly preferably by at least 30% with respect to a height difference of the bottom line to the height value assumed in the turning point region. In this way, it is advantageously achieved that the supporting foot itself (from the turning point region up to the turning point region of the other side of the supporting foot) is designed such that the height values drop quickly in a region adjacent to the supporting region.

The bottom line is preferably the bottom line described above (in which a progression of the height values has been described with respect to a height difference to the height value assumed in the groove base.

Due to the smaller distance of the height values in the regions between the supporting region and the turning region from the height values assumed in the groove base, a significantly better ability to be formed of the supporting foot (in particular its corner regions) is achieved.

Preferably, the bottom line is selected (also here) in such a way that it runs through the corner region described above and/or the bulged region described above and/or the flattening progression described above. A point of the bottom line which takes up 30% of an angle of rotation between the geometric center of the supporting region and the geometric center of the groove base of the adjacent groove is preferably located within the flattened region described above.

The above-described progression of the height values of a bottom line (in particular its proportional reduction of the height values) preferably applies to any bottom line which takes up a predetermined distance from the central axis, which distance lies between two predetermined distance values which differ from one another. The two predetermined distance values are preferably greater than the radius of a pitch circle of the container. The pitch circle is in particular the circular ring, on which the supporting surfaces (designed in the manner of a segment of a circle) of the supporting feet are arranged.

In a further preferred embodiment, a bulged region with a curvature progression of the same orientation adjoins in each case the flattened region of the supporting foot, viewed both in the direction of the adjacent groove and/or of the groove base of the adjacent groove and viewed in the direction of the supporting region of the supporting foot, wherein the amount of the curvature within the bulged regions (in each case) assumes at least one maximum (with respect to the amounts of the curvatures assumed within the flattened region). A curvature progression along an (unwound) bottom line is preferably considered here.

Both the bulged region arranged in the direction of the adjacent groove/groove base and the bulged region arranged in the direction of the supporting region have a (local or global) maximum with respect to the amount of the curvature—in each case compared to the amounts of curvature assumed within the flattened region.

Preferably, the bulged region arranged in the direction of the supporting region is assumed to be a higher amount of curvature than in the amount of curvature assumed in the direction of the groove/groove base. Preferably, the maximum amount of curvature assumed in the direction of the supporting region is at least twice, preferably at least four times, and particularly preferably at least ten times as great as the maximum amount of curvature assumed in the direction of the groove/groove base.

The maximum of the amount of curvature assumed in the bulged region is thereby greater than a (local) maximum assumed in the flattened region. If an (unwound) bottom line is considered through the flattened region, the maximum amount of curvature which is assumed in the bulged region is preferably at least five times, preferably at least ten times and preferably at least twenty times as great as a (any) maximum amount of curvature which is assumed along the bottom line within the flattened region.

It is thereby advantageously achieved that the regions of greater amounts of curvature are arranged in regions which lie closer to the supporting region and closer to the groove base or the groove. This advantageously makes it possible to clearly improve the ability to be formed of the supporting foot and therefore allows a reduction of the final blowing pressure.

The curvature progression can be, for example, a progression of a curvature in a main direction of curvature or a progression of a surface curvature. It is also conceivable that the curvature progression is the progression of a curvature in a predetermined direction. As mentioned above, it is also conceivable that the curvature progression is considered with respect to a predetermined line which runs through the corresponding bulged region and the flattened region.

In addition, it is preferably alternatively or additionally also possible for a bulged region with a curvature progression of the same orientation to adjoin the flattened region of the supporting foot, in the direction of the base center and/or in the direction of the main body, wherein the amount of the curvature within the bulged regions (in each case) assumes at least one maximum compared to the amounts of curvature assumed within the flattened region of the supporting foot. A curvature progression along a longitudinal sectional contour is preferably considered here. The longitudinal sectional contour thereby preferably results from a longitudinal section of the bottom region through the flattened region, wherein the longitudinal section is carried out along a longitudinal sectional plane running through the central axis. Even along such a longitudinal sectional contour, regions of maximum amounts of curvature are preferably not arranged within the flattened region, but in the (adjacent) bulged regions. This offers the advantage that high amounts of curvature, which are more difficult to shape, are avoided in the corner region of the supporting foot.

In a further preferred embodiment, a cross-sectional contour formed by a longitudinal section through the bottom region, the longitudinal sectional plane of which runs through the flattened region of a supporting foot and through the central axis of the plastic container, has a curvature progression which assumes a local minimum in the flattened region compared to the surrounding portions, preferably compared to the bulged region.

In a further preferred embodiment, the bulged region surrounds the flattened region at least substantially around half the circumference and preferably substantially around the full circumference. This offers the advantage that large amounts of curvature in the flattened region can thereby be avoided.

In a further preferred embodiment, the amount of the surface curvature within the entire flattened region is smaller than the amount of the surface curvature of the bulged region surrounding the flattened region at least around half the circumference and preferably around the full circumference.

In a further preferred embodiment, the flattened region tapers in the direction of the groove base. The flattened region is preferably designed to be triangular, wherein the tip of the triangle is oriented in the direction of the main body and/or in the direction of the groove base. This results in a smaller flattening in a region that is less critical with regard to an ability to be shaped, and a greater flattening in a region that is more critical with regard to an ability to be shaped.

In a further preferred embodiment, the flattened region is substantially flat. It is also conceivable that the flattened region is flat in portions. The flattened region is preferably designed to be flat in its entirety. A flat design allows a good ability to be shaped.

In a further preferred embodiment, the flattened region has a surface area which amounts to at least one quarter, preferably at least one third, preferably at least half of the surface area, preferably at least the same surface area, preferably at least twice and particularly preferably at least three times the surface area of the, in particular substantially flat, supporting surface of the supporting region of the supporting foot for standing the plastic container upright.

In a further preferred embodiment, the at least three supporting feet each have two flattened regions, in particular arranged symmetrically and/or preferably mirror-symmetrically to one another, which, in cross-section, at least in portions (preferably within the flattened region completely) follow the progression of the legs of a preferably isosceles triangle.

In a further preferred embodiment, a distance (a so-called offset) between a tip of the preferably isosceles triangle and the supporting foot, in particular the supporting region of the supporting foot, is between 0 mm and 20 mm, preferably between 2 mm and 10 mm.

In a further preferred embodiment, an opening angle of the triangle which encloses the tip of the triangle (i.e. the opening angle or inner angle of the triangle at the tip of the triangle in which the preferably equally long two legs of the triangle meet, in particular the angle which these two legs enclose) is between 45° and 170°, preferably between 80° and 150°, preferably between 80° and 120°, preferably between 90° and 120°, and particularly preferably between 90° and 110°. Opening angles between 105° and 106° have proven to be particularly advantageous.

Preferably, both flattened regions each follow, in cross-section, the progression of one leg of the same, preferably isosceles, triangle at least in portions and preferably within the entire flattened region. Such flattened regions are preferably created by using two intersecting planes with an angle of intersection which corresponds to the angle at the tip of the triangle considered above (so that the two planes lie against the legs of the (hypothetical) triangle). As described in the context of the figures, the two planes are preferably arranged around the supporting foot (in the manner or shape of an open book).

The flattened regions can be created constructively in such a way that intersecting regions of the supporting feet with the planes are cut off.

The two planes and/or the triangles are preferably arranged along the supporting foot by means of a guide contour.

The guide contour is preferably constructed on the center of a (supporting) foot, particularly preferably with the aid of the sectional contour (of the supporting foot and particularly preferably of the supporting region). Preferably, the sectional contour of the supporting foot along the geometric center of the supporting region is used.

There are various advantageous variants of the guide contour.

### Variant A

A perpendicular is constructed on the radius of the foot with the aid of a straight line. The straight line is controlled by an angle. The angle moves between the perpendicular through the center point of the foot radius to the supporting surface and the straight line. The values are preferably between-30 degrees and 80 degrees, preferably between −10 and 65 degrees.

Preferably, a tangent is created perpendicular to the straight line (in the next design step). Parallel to the tangent, a straight line is created at a predetermined distance as a guide contour. The predetermined distance ranges between 0 and 20 mm, preferably between 2 and 10 mm. The length of the straight line can be defined.

### Variant B

Here, an offset curve of the sectional contour of the foot is preferably used (as a guide contour). With a preferred distance of 0 to 20 mm, preferably between 0 and 10 mm. The length of the offset curve can be determined by the percentage determination of the starting point and end point. The preferred distance of the offset curve can go from −10 mm to +20 mm, preferably between 0 and 10 mm.

In a further preferred embodiment, the flattened region follows a substantially parabolic progression. The flattened region preferably follows a branch of a parabola (at least in portions and preferably within the substantially entire flattened region). Preferably, both flattened regions of a seat foot follow a substantially parabolic progression. A cross-section through the seat foot and the two flattened regions preferably follows a parabola at least in portions and preferably along the entire flattened regions.

Preferably, the parabola is arranged on a guide contour for the construction of the two flattened regions. In this case, the guide contour can be selected as described above in connection with a triangle to construct the flattened regions, according to one of the described embodiments.

In a further preferred embodiment, the supporting foot has at least two, in particular symmetrically arranged, flattened regions, and the two flattened regions and the supporting region of the supporting foot follow, in cross-section, a progression of an open, in particular isosceles, trapezoid at least in portions. Here too, a guide contour can be selected as described above to construct the flattened regions.

A supporting foot with a preferred foot structure described below from the prior art is preferably used to construct the supporting feet with flattened regions. The supporting foot used for the construction preferably has side flanks which preferably represent free-form surfaces.

A construction of a supporting foot (with flattened regions) can also be understood to mean a construction of an inner surface of a blow molding device, which corresponds to the constructed shape of the supporting foot, for creating such a supporting foot.

A guide contour and at least one, preferably exactly one or exactly two transverse contours are preferably used to construct the supporting foot. The transverse contour(s) predetermines or predetermine an at least portion-wise progression of the created flattened regions.

The transverse contour can be described by the following preferred variants.

### Variant Z

Has the geometry of a triangle with an opening angle between 45 and 180 degrees, preferably between 80 and 150 degrees. The height is preferably defined between 2 and 50 mm.

### Variant Y

A trapezoidal geometry with the short side of the trapezoid downward in the direction of the supporting surface and/or the supporting region. The length of the short trapezoid side is preferably between 0.5 mm and 10 mm. The internal angles are preferably the same. The internal angle is preferably between 91 and 170 degrees, preferably between 95 and 155 degrees.

### Variant X

Is a parabolic contour, which is preferably given by a quadratic function, the apex is located the guide contour. y=ax\hat{ }2+bx+c Preferably, the parameter a is greater than 0, the parameter b is preferably greater than 0 and the parameter c is preferably between −10 and 10 mm, preferably between −5 mm and 5 mm.

The guide contour can preferably be realized by the two possibilities described above as variant A and variant B.

The variants of the guide contour can be combined with the transverse contour variants, as follows.
A with X, Y and/or Z
B with X, Y and/or Z
or
X with A and/or B
Y with A and/or B
Z with A and/or B

A further preferred transverse contour can also be described by a polynomial of the nth degree, wherein the value of n can move between 2 and 7.

For variant B with an offset curve or approximated offset curve, 2 transverse contours with adapted values are required.

An offset curve is understood in particular to mean a spline, with a polynomial of the nth order, wherein the value of n can move between 2 and 7.

In a further preferred embodiment, the, in particular both, foot side regions of the supporting foot are designed in portions as foot flank surfaces formed by a free-form surface, wherein the foot side regions are preferably designed as free-form surfaces substantially completely outside of the bulged region.

The foot flank surface is preferably designed as a free-form surface that is preferably connected to the surface edges of the supporting foot and/or a foot region and in particular to the surface edges of the main body (and in particular a central region and/or an injection point)—in particular, in a tangentially-continuous manner and preferably in a curvature-continuous manner. In particular, the free-form surface is a surface whose curvature progression in one (each) direction can be described by polynomials of the nth degree.

In particular, a tension band arranged in the bottom region of a container—in particular, provided between the supporting feet—serves to transfer forces acting upon the bottom center point or the bottom center—such as an injection point of a plastic container—to a side wall of the plastic container via the tension band.

Thereby, a groove can be understood as a geometric structure that extends inwardly (in particular, for example, in the direction of the container mouth and/or the central axis) with respect to the (outer) wall of the container (surrounding it), i.e., for example, the (outer) wall of the bottom region—in particular, with respect to a normal level of the circumferential wall. The groove is preferably the region between two turning point regions which, as described above, extend by a turning point circumferential angle.

A groove base can be understood as a (partial) region of a groove that differs from at least one further region and in particular from the remaining region of the groove and/or from a foot flank surface of a supporting foot due to its (uniform or common) geometric construction, such as uniform parameters of a surface parameterization and/or selection of a surface (or a common rule for the surface construction).

The groove base can be understood as, for example, the (in particular, contiguous) region of a groove that substantially forms the (minimum) region extending (furthest) inwardly (and the region surrounding this). Thereby, the groove base preferably differs from the remaining region of the groove in that it has been constructed according to a different surface shape compared with the remaining region of the groove and, in particular, with a region of the groove arranged laterally adjacent to the groove base, which is located between the groove base and the supporting foot. Preferably, the above-described region adjacent to the groove base and located between the groove base and the supporting foot is (in its entirety) part of a foot flank surface of a supporting foot (and, in particular, constructed accordingly as such).

Preferably, the main body serves to hold the substantial filling volume (of a beverage). The main body has a completely circumferential (side) wall in a circumferential direction. Thereby, the main body can have a substantially circular (preferably circular) cross-section (with predetermined main diameter, cross-section when cut in a plane perpendicular to the central axis). It is also possible, however, for the main body to have a substantially square or rectangular cross-section—in particular, with rounded corners.

Preferably, the (in particular each) groove base (or a tension band), in particular in each case, has two lateral tension band regions, in which the wall of the container (in particular of the bottom region) is curved outwards, and a central tension band region which is arranged between the two lateral tension band regions in the circumferential direction, wherein the wall of the container is bulged inward in the central tension band region. In particular, the two lateral tension band regions and the central tension band region (in the circumferential direction) arranged between the two lateral tension band regions are arranged between two (adjacent) supporting feet. The surface of the central tension band region is bulged in particular towards the container interior or bottle interior.

Preferably, the two lateral tension band regions each form an outer tension band region (viewed in the circumferential direction) and/or an outer groove base region. Preferably, the (in particular, each) groove base or the (in particular, each) tension band (viewed in and/or against the circumferential direction) is bounded by one of the two lateral tension band regions (in the direction of an adjacent supporting foot).

The wall of the container in the bottom region is in particular inwardly bulged at least in sections in a central region (the central tension band region) of the groove base of a groove, and outwardly bulged in the two edge regions of the groove base adjacent to the central region of the groove base (in particular, the lateral tension band regions).

The present invention offers the advantage that the bulge towards the (bottle) interior causes the tension band to fit better into the bottom geometry. This allows the material to be stretched more easily into the feet or the supporting legs. This preferably avoids the formation of distortions and increases stability. Furthermore, the ability for blowing and forming are improved.

In other words, the bottom region has a concavely curved or concavely bulged container outer surface in the central tension band region. Preferably, such concave curvature or concave bulge is present substantially along the entire line segment between the injection point and/or between a central region around the injection point and the boundary of the bottom region towards the main body.

In particular, the bottom region has a convexly curved or convexly bulged container outer surface (in each case) in the lateral tension band region. Preferably, such convex curvature or convex bulge is present substantially along the entire line segment between the injection point and/or between a central region around the injection point and the boundary of the bottom region towards the main body.

Preferably, a base contour of the bottom region of the container in the

supporting region (in particular in the entire supporting region) of a supporting foot can be described by a base contour in such foot region, which preferably first has a rectilinear portion (in particular, starting from a geometric center point of the container and/or an injection point and/or a central portion), which is adjoined by a spline or curved portion. Such curved portion is preferably followed by a further curved portion or spline, and preferably by a further curved portion, with which the bottom region merges into the main body. The supporting region or the foot surface, in particular the supporting foot and/or the supporting region, is preferably created from such base contour by rotating the base contour about the central axis of the container selected as the axis of rotation. Explicit reference is made to patent application DE 10 2013 110 139 A1 of the applicant, in which such a preferred geometry of the supporting region or of the foot region of the bottom region (bottom portion therein) is described (and illustrated in FIG. 2 and FIG. 3). All features described in this application with respect to the region (referred to here as the supporting region) of the supporting foot (and the curvature progression thereof) are also hereby to be deemed disclosed by reference.

Preferably, the groove base and/or the central tension band region and/or the two lateral tension band regions extends/extend radially outwardly (following the progression of the bottom wall in the longitudinal direction) from the injection point or a central region surrounding it, substantially up to (or almost up to) the main body. Preferably, the groove and/or the groove base and/or the central tension band region and/or the two lateral tension band regions extends/extend over at least 75%, preferably at least 80%, and particularly preferably at least 90%, of the arc length of a line starting from the injection point and/or the central region and formed from there on the bottom wall in the radial direction outwardly to the main body.

Preferably, the groove and/or its groove base (and, in particular, at least one arranged groove and/or its groove base extends between each of two supporting feet) extends in the radial direction (at least with one component). Preferably, the main direction of extension of the groove and/or the groove base in a projection of the groove or the groove base on a plane perpendicular to the longitudinal axis runs substantially and in particular exactly along a radial direction.

Preferably, at least one and preferably exactly one groove (with a groove base extending in the circumferential direction over a (predetermined) circumferential angle) is arranged between each two supporting feet arranged to be adjacent (laterally or in the circumferential direction), wherein, preferably, the respective groove has a main direction of extension running in the radial direction (wherein, in particular at least one component of the main direction of extension in each case points in a radial direction).

Preferably, a (each) groove base (and/or each groove) extends substantially along each bottom height section of the groove base, (wherein a bottom height of a section in the longitudinal direction is measured with a supporting plane on which the container stands as a reference plane)—in particular, substantially—over the same (predetermined) circumferential angle. This means that a region of the groove base closer to the supporting surface extends over substantially the same (predetermined) circumferential angle as a region of the groove base closer (viewed in the longitudinal direction) to the main body and/or the mouth region.

In other words, a projection of the groove base and/or a projection of the central tension band region and/or a projection of the (in particular, respective) lateral tension band region (against the longitudinal direction) onto a supporting plane of the container (which is arranged perpendicular to the longitudinal direction) occupies a segment of the respective projection surface (of the bottom region) that can be defined and/or described substantially by a circumferential angle.

Preferably, a groove base (in each case) is arranged substantially and, preferably, exactly symmetrically (with respect to the circumferential direction) between two (adjacent) supporting feet. Preferably, a (each) groove and/or a (each) groove base is designed to be (axially) symmetrical with respect to a plane that extends in the longitudinal direction of the central axis or longitudinal direction of the container, and in a (radial) direction along the geometric center (viewed in the circumferential direction) of the groove and/or groove base.

Preferably, in the geometric center of a groove and, in particular, in the geometric center of a groove base, there is a wall region of the bottom region, which, with respect to wall sections in the circumferential direction, extends furthest (in the radial direction and/or towards the central axis) into the interior of the container. In other words, in the case of a line formed (exclusively) along the circumferential direction and running along the bottom wall (in particular, along the outer surface of the bottom region), the line section at the geometric center of a groove base is located closest to the central axis. Preferably, this line running (exclusively) along the circumferential direction has an inward bulge in the region of the groove base at least in sections, and preferably in the entire region of the groove base. If a section of the base region is formed with a plane perpendicular to the central axis, the plane is bulged inwards (towards the central axis) in the region of the groove base (in particular, in such entire region). Preferably, a turning region in which such bulge or curvature reverses and/or changes its orientation is located (exclusively) outside the groove base.

In a preferred embodiment, the central tension band region extends at least in sections along the geometric center of the groove base and is preferably symmetrical with respect to the geometric center. In particular, the wall of the container is bulged inwardly at least in sections and preferably substantially along the geometric center of the groove base (in particular, when considering a main direction of the surface corresponding to a circumferential direction). This results in a particularly stable base geometry due to the symmetrical arrangement.

In a preferred embodiment, the groove base has at least a first and a second turning region, in which a surface region of the groove base changes the orientation of its bulge. Preferably, in the first turning region, the orientation of the first lateral tension band region (an outward bulge) changes to the orientation of the center tension band region (an inward bulge). Furthermore, in the second turning region (which is different from the first turning region), the orientation of the central tension band region (inward bulge) changes to the orientation of the second lateral tension band region (outward bulge).

Preferably, at least one (in particular, each) line running on the surface of the bottom region in the groove base, which extends along the circumferential direction (which in particular does not extend along the longitudinal direction), has a first turning region, in which a surface region of the groove base changes the orientation of its bulge and in particular is transferred from an outwardly-bulged region to an inwardly-bulged region. Furthermore, the line has a second turning region in which a surface region of the groove base changes the orientation of its bulge and, in particular, is transferred from an inwardly-bulged region to an outwardly-bulged region.

In a preferred embodiment, the tension band and/or the groove base is a rotated surface, i.e. a surface which arises in the circumferential direction about the central axis (about the groove base circumferential angle) by rotation (of a tension band contour extending in particular in a longitudinal sectional plane through the central axis).

In a preferred embodiment, the tension band (which is implemented in particular by the groove base) is a free-formed bottom section. In particular, compared to the above-mentioned rotated surface, is replaced by a free-form surface. A free-form cut makes it possible to distribute the material in a more targeted manner, even within the tension band. In this manner, (visible) distortions in particular, which can lead to weakening of the tension band, can also be avoided. This increases the stability of the bottom.

Free-form surfaces are understood as in particular three-dimensional, usually doubly-curved surfaces, which can preferably (in particular, only) be represented mathematically by splines (piecewise polynomial functions) and/or by NURBS (non-uniform rational B-spline).

In particular, the tension band or the groove base is preferably designed as a free-form surface, which is connected to the surface edges of a foot flank surface or a transition region arranged to the side of a supporting foot, and to the main body of the container and to a central region around an injection point or at the injection point—in particular, in a tangentially-continuous manner and in particular in a curvature-continuous manner. The curvature progression of the free-form surface of the groove base in (any) predetermined direction can be described by polynomials of the nth degree.

Preferably, at least one, preferably at least two, and preferably at least three, characteristic parameters for the free-form surface of the groove base are selected and/or determined, e.g., approximated, in such a manner that the geometric shape of the free-form surface approximates a region of a spherical surface and, in particular, has a hemispherical (segmental) shape.

In an advantageous embodiment, a groove base cross-sectional contour in a cross-section perpendicular to the longitudinal direction of the container follows, at least in sections and preferably substantially completely, a spline of the nth degree, which deviates at least in sections from a circular line-shaped progression—in particular, in the central tension band region and/or the two lateral tension band regions. Advantageously, this allows the surface (of the central tension band region) to be bulged towards the bottle interior and to be variable in cross-section. This causes the tension band to fit better into the bottom geometry.

In a preferred embodiment, at least one groove (preferably each groove) (preferably between two supporting feet) has a groove circumferential angle that is between 10° and 60°, preferably between 20° and 50°, preferably between 30° and 38°, and particularly preferably 34°.

In a preferred embodiment, at least one groove base (preferably each groove base of each groove between two supporting feet) extends over a groove base circumferential angle which is between 2.5° and 10°, preferably between 3° and 7°, preferably between 4° and 6°, and particularly preferably 5°. This allows a sufficiently functional tension band to be achieved.

Preferably, a groove base (preferably each groove base) of a groove between two supporting feet takes up substantially exactly one extension as viewed in the circumferential direction, which corresponds to an angular segment over the predetermined groove base circumferential angle. Viewed in the circumferential direction, a groove base in particular thus extends along its entire extension along the longitudinal direction over the (substantially exactly over the) predetermined groove base circumferential angle.

Preferably, a groove (preferably each groove base) between two supporting feet takes up substantially exactly one extension as viewed in the circumferential direction, which corresponds to an angular segment over the predetermined groove circumferential angle. Viewed in the circumferential direction, a groove base in particular thus extends along its entire extension along the longitudinal direction over the (substantially exactly over the) predetermined groove circumferential angle.

In a further advantageous embodiment, the groove base and/or the groove is designed to be substantially symmetrical to the geometric center of the groove base. The symmetrical design results in a particularly stable base geometry.

In a further advantageous embodiment, a region, arranged between a supporting foot and a groove base, of the bottom section merges into the groove base in a tangentially-continuous and/or curvature-continuous manner. This also results in particularly good stretching of the material into the feet tips.

In a further advantageous embodiment, the groove base of (each) groove (between two adjacent supporting feet) merges into the remaining region of the groove (and/or into a supporting region) and/or into a foot flank surface (of a supporting foot) in a region whose main direction of extension extends (substantially exclusively) in the radial direction on the bottom region wall and, in particular, not in the circumferential direction.

Preferably, the transition region from a groove base of (each) groove into the remaining region of the groove and/or into a foot flank surface (of a supporting foot) is given by a line formed on the base region, which extends along the bottom region (substantially exclusively) in the radial direction towards and not in a circumferential direction.

In a further advantageous embodiment, a (preferably, each) region, arranged between a supporting foot and a groove base, of the bottom section merges into the groove base in a tangentially-continuous and/or curvature-continuous manner. In other words, one (in particular, each) region, arranged adjacent to the side of the groove base (viewed in the circumferential direction), of the bottom section (in particular, a foot flank surface) merges into the groove base in a tangentially-continuous and/or curvature-continuous manner. In such section, the tangent continuity or curvature continuity is viewed in particular with consideration of a transition in the circumferential direction and/or along a bottom line and/or at a radial viewing direction. Such a tangentially-continuous and/or curvature-continuous transition offers the advantage that plastic material to be distributed during a blow molding process can be moved or stretched, e.g., from the groove base (along the foot flank surfaces), into a supporting foot with as little friction as possible caused by the geometric shape (of the corresponding blow mold).

In a further advantageous embodiment, the groove base follows a circular sphere-like progression at least in sections (preferably at least the region of the groove base arranged between two supporting feet, viewed in the circumferential direction) and in particular substantially along its entire extension in the radial direction. Preferably, the bottom region between each two (adjacent) supporting feet has a region (extending substantially from a central region and/or injection point to the main body of the container), which has a circular spherical (segmental)-like progression. This offers the advantage that the advantageous geometric properties of a circular spherical (segmental) wall in terms of force transmission can be largely retained when the surface of the wall is (largely) approximated to a circular spherical (segmental) progression.

Preferably, the groove base deviates at least in sections and in particular in one (each) region between two supporting feet (viewed in the circumferential direction) from a (substantially) exactly hemispherical (segmental) wall section or progression. In other words, preferably no region of the groove base follows a strictly geometric hemispherical (segmental) progression.

By a hemispherical progression of a region, it is understood in particular that such region deviates no more than 20%, preferably no more than 10%, preferably no more than 5%, and particularly preferably no more than 2.5%, of a spherical radius from a sphere approximated to the region (in particular, in the radial direction with respect to the spherical center point of the approximated sphere).

Preferably, the groove base can be inscribed at least in portions—preferably a portion of the groove base selected (in particular, in its entire extension in the circumferential direction)—between two supporting feet and particularly preferably in its entirety between two (hypothetical) circular spherical surfaces whose spherical radii deviate from one another by less than 20%, preferably less than 10%, preferably less than 5%, and particularly preferably less than 2.5%.

Preferably, a line formed along the geometric center between two adjacent supporting feet and/or the geometric center of the groove and/or the geometric center of the groove base on the wall deviates from an arc of a circle approximated thereto at least in portions (at any point of the formed line) by less than 20%, preferably less than 10%, preferably less than 5%, and particularly preferably less than 2.5%, of the radius of the approximated circular line with respect to a geometric distance of such formed line from the approximated circular line. Preferably, the line thereby formed takes up more than 20%, preferably more than 30%, preferably more than 40%, preferably more than 50%, preferably more than 60%, preferably more than 70%, preferably more than 80%, and particularly preferably more than 85%, of the arc length of a connecting line formed on the wall, running through the geometric center between two adjacent supporting feet and/or through the geometric center of the groove and/or the groove base, between, on the one hand, the base center point and/or the injection point and, on the other, the transition of the base region into the main body. Preferably, such formed line can be described (at least in sections and preferably in a region of more than 85% of the arc length) by a spline of the nth degree. However, it is also conceivable that such formed line be able to be described by a circular line.

In a further advantageous embodiment, the groove base (or the tension band) is not a surface that is rotationally symmetrical about the central axis of the container (in particular, in its entirety, and preferably also not at least in sections). This distinguishes the construction of the groove base from that of a groove base known in the prior art, in which the base contour tension band is rotated at both ends of an angular segment about a central axis through a tension band angle. A deviation from a rotationally-symmetrical surface section offers the advantage that this allows the curve progression to be adapted (in particular, with regard to the curvature), while at the same time maintaining a largely hemispherical segmental shape.

The mouth region preferably has an external thread and/or a support ring. Preferably, the bottom region has an injection point located in particular on the central axis, and the bottom region preferably has a central region surrounding such injection point—in particular, of rotationally-symmetrical design. Preferably, the injection point is located above the supporting feet of the container, viewed in the longitudinal direction (when the container is upright).

Preferably, the supporting feet or outer surfaces of these (in each case) form an in particular flat—in particular, extending (exclusively) in a plane perpendicular to the longitudinal direction, and preferably at least partially ring segment-shaped, extending over a predetermined circumferential angle-supporting section of the plastic container.

Preferably, the container has a filling volume (of a beverage) of at least 0.1 l, preferably at least 0.2 l, preferably at least 0.3 l, preferably at least 1 l, preferably at least 1.5 l, preferably at least 2 l, preferably at least 3.5 l, and in particular at least 5 l. Preferably, the container has a maximum filling volume of 5 l, preferably of 3.5 l, preferably of 2 l, preferably of 1.5 l, and preferably of 1 l. Preferably, the container has a filling volume in a range between 2 l and 3.5 l.

Preferably, the container is suitable for carbonated beverages.

Preferably, the bottom region has more than three, preferably more than four, preferably more than five, and particularly preferably more than seven supporting feet. Preferably, the bottom region has less than ten, preferably less than eight, preferably less than six, and particularly preferably less than four supporting feet. Preferably, the container has a petaloid base.

The container base preferably has a discrete axial symmetry with respect to the central axis.

In a further advantageous embodiment, the container bottom has a substantially constant wall thickness at least in sections, and preferably over the entire surface. In particular, a wall thickness in the region of a supporting foot and the region of a groove base is substantially the same. This makes it possible to achieve the greatest possible stability of the container or container bottom, while using as little material as possible.

The present invention is further directed to a blow molding device for producing, in particular a bottom region of, plastic containers having an inner wall, against which a plastic container (preferably created from a plastics preform by blow molding) can be expanded during a blow molding process.

According to the invention, the inner wall has a contour that is suitable and intended for creating a plastic container, wherein the plastic container can be designed with all the features described above in connection with the plastic container, alone or in combination with one another.

In particular, the blow molding device has a bottom part or is designed (exclusively) as a bottom part that is suitable and intended for producing a bottom region of the type described above.

The bottom part is preferably used to form a cavity (in the assembled state or in the operating state) with at least two blow mold side parts, within which cavity plastics preforms can be molded by applying a flowable (preferably gaseous) medium to the plastic containers, wherein an inner wall of the blow mold side parts and of the bottom part bounding the cavity has a contour which creates a predetermined shape of the containers to be produced.

In addition to the bottom part, the blow molding device can also have the (preferably releasably connectable to the bottom part) (blow mold) side parts.

The blow molding device preferably has a plurality of openings, in particular for venting the blow molding device. The openings provided in particular for venting allow a fluid and preferably gaseous medium to be discharged during an expansion process of the plastic container.

In an advantageous embodiment, the blow molding device has at least one supporting foot forming region for producing a supporting foot of the plastic container, wherein the inner wall and/or the inner contour of the blow molding device has at least one flattened region and preferably two flattened regions in the region of the supporting foot forming region.

In a further advantageous embodiment, each supporting foot forming region of the blow molding device designed to form a supporting foot has at least one opening, in particular (in particular for venting the blow molding device), provided for venting the blow molding device, and preferably a plurality of openings (in particular for venting the blow molding device), provided in particular for venting the blow molding device, wherein the at least one opening is arranged at least in regions and preferably completely in the flattened region of the blow mold.

By arranging at least one opening in the flattened region, it is advantageously achieved that the flowable medium which accumulates between the plastic container produced from a plastics preform and the inner side of the blow molding device (by the displacement brought about by the expansion of the container) during molding, in particular in the corner region of the supporting foot of the bottom region (which is most recently finished in the blow molding process), can be vented through the opening in the flattened region, and the formation of a high counter pressure can thereby be prevented.

As complex experiments have shown, such a combination of the opening with the design of the container or the bottom shape with a flattened region (in the corner region of the supporting foot) advantageously achieves that, in particular, the corner regions of the supporting feet that can be produced in a sufficient high quality in the prior art only when using high final blowing pressure can now also be produced with the aid of a significantly lower final blowing pressure, with equally qualitatively high-quality results.

A ratio between a surface of the bottom part and a surface of the openings (preferably all openings (in particular arranged in the bottom part) provided for venting the blow molding device) is preferably 3-350, preferably 4-200 and particularly preferably 5-100.

Advantageously, the ratio between a surface of the bottom part and a surface of the openings is 25-180, preferably 35-175, and particularly preferably 47-169. The preferred or advantageous ratio depends in particular on the size of the bottle or the bottle volume and the shape of the openings.

For example, with a bottle volume of 0.5 l, a ratio between a surface of the bottom part and a surface of the openings, which are preferably holes or bores, of 169 is preferred. In this example, the ratio between a surface of the bottom part and a surface of the openings is advantageously 145-180, preferably 150-175 and particularly preferably 155-173.

It is accordingly proposed according to the invention that the ratio between the surfaces of the openings and the bottom part, independently of the diameter of the bottom part, is always approximately the same, i.e., that with a larger diameter, the surface which the openings take up are also correspondingly larger. This can be achieved, for example, by more openings or also larger openings compared to a smaller diameter of the bottom part. A sufficient venting can thereby be ensured at each blow mold size or container size.

The surface of the openings is understood here to mean the surface which the openings in the form of holes, slots or any other shapes on the bottom part take up or have.

It was found in internal investigations by the applicant that the ratio between the surface of the bottom geometry and the surface of the openings and in particular venting openings or venting bores has an influence on the venting.

In the internal investigations and tests of the applicant, it has been found that, starting from this example, a plastic container having a diameter of 65 mm has achieved very good final blowing pressure results. The ratio between the surface of the bottom geometry and the surface of the venting openings for a test container having a diameter of 100 mm is therefore preferably adapted to the ratio of the container diameter of 65 mm. Preferably, the surface of the (venting) openings of this container is substantially 0.000094 m² (94 mm²).

The bores or openings are preferably designed in such a way that, on the one hand, they are large enough to allow venting or to allow a sufficiently large flow cross-section, but still small enough that no material of the plastic container is pushed into the openings during molding and no visible and/or perceptible regions are formed on the finished plastic container.

The openings preferably open into channels which extend through the wall of the blow mold and the bottom part, so that the flowable medium is preferably discharged from the blow mold via the channels. Accordingly, channels which serve to discharge the gaseous medium preferably adjoin the openings within a wall of the blow mold parts and in particular of the bottom part. Advantageously, these channels extend at least partially through the wall of the bottom part. The channels preferably establish a flow connection between an outer wall of the bottom part and an inner wall of the bottom part and thus preferably also between an interior of the blow mold and an exterior of the blow mold.

In a preferred embodiment, an (in particular maximum) diameter of the bottom part or of the blow molding device is between 50 mm and 200 mm and the surface of the openings is between 23 mm² and 500 mm² and/or the surface of the bottom part is between 3900 mm² and 65000 mm² and the surface of the openings is between 23 mm² and 500 mm². Combinations of the diameter of the bottom part, surface of the openings and surface of the base part, which result in a ratio between the surface of the openings and the surface of the bottom part of preferably 160 to 175 and particularly preferably almost 169, are advantageous in this case, since such a ratio ensures the lowest compressed air consumption with the greatest possible container quality. This ratio is in particular advantageous for bottle volumes of 0.5 l and the formation of the openings as holes.

In a further preferred embodiment, the openings are a plurality of holes and/or slots which are arranged in the bottom part and in particular the regions of the bottom part which serve to form the supporting regions of the finished container. A combination of slots and holes is also preferred in this case.

If the openings are designed as slots, for example, a ratio of 169 still provides satisfactory results, but the bottle quality can be further advantageously improved at a ratio of up to 47, so that the ratio between the surface of the openings and the surface of the bottom part when the openings are designed as slots is preferably 40-180, preferably 45-170, and particularly preferably 47-169.

If the openings are designed as a combination of slots and holes, the ratio between the surface of the openings and the surface of the bottom part is preferably 30-50, preferably 33-45 and particularly preferably 35-41.

The holes can preferably be arranged in an ordered manner along at least one and preferably at least two imaginary geometric lines. However, an unordered arrangement of the holes is preferably also conceivable, for example, in a targeted manner in regions in which the supporting regions of the container are difficult to be formed, such as, for example, very narrow or small regions.

Preferably, a slot can also be formed by an arrangement of a plurality of holes or bores, which are preferably arranged along a row or a spline. A plurality of holes preferably extends along at least one geometric line. The holes are preferably arranged next to one another along two or more rows so that at least two rows of holes extend next to one another along geometric lines. The number of holes of the venting bores in the bottom part is preferably again dependent on the required or desired venting bore surface in relation to the surface of the bottom part.

The openings and/or holes are preferably arranged in three rows.

The holes of the individual rows can preferably be arranged directly next to one another at the same height or offset relative to one another. The holes preferably have a diameter of preferably 0.2 mm to 7 mm, preferably 0.3 mm to 5 mm, and particularly preferably 0.5 mm to 4 mm. The distances of the individual holes in a row relative to one another are preferably the same or different. Preferably, the distance is 0.6× to 2.5× the diameter of the holes and particularly preferably 0.5× to 2× the diameter of the holes.

On an outer side of the bottom mold, the openings and in particular the plurality of holes arranged along a row are preferably guided within a channel in order to discharge the gaseous medium from the bottom mold more quickly. In this case, the channel preferably has a width which is multiple times a diameter of the holes.

Each portion of a bottom part preferably has a specific drilling pattern. The drilling pattern in a foot and/or a portion of the bottom part can preferably consist of an arrangement of a plurality of rows and columns. The drilling pattern is preferably arranged centrally within the portion of the bottom part. The holes or venting bore preferably all have the same diameter or different diameters. With different diameters, the diameters are preferably in a ratio between 0.25 and 10, preferably between 0.4 and 8, and particularly preferably between 0.5 and 6. Here too, the number of holes of the venting bores in the bottom part is preferably again dependent on the required or desired venting bore surface in relation to the surface of the bottom part.

In a further preferred embodiment, the bottom part is designed to form supporting feet of the plastic container, wherein each supporting foot has a plurality of openings. Preferably, three to twelve supporting regions are arranged in the bottom part for forming three to twelve supporting feet of the plastic container.

The openings are accordingly preferably arranged in a region of the bottom part which serves to form supporting regions of the container. The openings are therefore preferably arranged in curved portions of the bottom part.

In a preferred embodiment, each supporting foot or each region of the bottom part serving to form supporting regions of the container has 7-35 openings, preferably 8-30 openings, and particularly preferably 10-25 openings. Overall, a bottom part having five supporting regions accordingly has 35-175 openings, preferably 40-150 openings, and particularly preferably 50-125 openings.

In a further preferred embodiment, at least one hole has a diameter which is between 0.5 mm and 4 mm, preferably between 0.8 mm and 2 mm. Particularly preferably, in order to avoid an excessive formation of the venting openings on visible surfaces or functional surface on the bottom, the diameters of the openings should not be greater than 2 mm, and not less than 0.8 mm. At other locations, the openings can preferably be up to 5 mm in order to realize rapid venting.

A distance between two openings arranged next to one another is preferably less than 4 mm, preferably less than 3 mm and preferably less than 2 mm. In particular, there must be sufficient material between two adjacent openings and in particular holes or bores, so that they do not run into one another or merge into one another. The minimum distance between two bores, from bore edge to bore edge, is preferably 0.2 mm. The distance between two openings arranged next to one another and in particular holes is accordingly preferably between 0.5 mm and 4 mm, preferably between 0.4 mm and 3 mm, and particularly preferably between 0.2 mm and 2 mm.

In a further preferred embodiment, at least one slot has a width which is between 0.4 mm and 2 mm, preferably between 0.5 mm and 1 mm, and particularly preferably between 0.6 mm and 0.8 mm. The slots are preferably arranged on the bottom part by wire erosion, milling, die sinking or laser cutting. Depending on the cutting or slot width, a rectangular cross-section can be created.

Each supporting region or each region of the bottom part which serves to form supporting regions of the plastic container preferably has between one to four slots.

Preferably, the at least one opening arranged in the flattened region of the supporting foot forming region has a larger surface or a larger opening diameter, preferably a surface and/or opening diameter (and/or flow cross-section) that is twice as large and particularly preferably three times as large as the openings arranged outside of the flattened region. The flattened region of the supporting foot forming region preferably has exactly one opening. This advantageously takes into account that this region of the supporting foot is not shaped as quickly as the remaining regions of the supporting foot during the blow molding process of the container. A particularly high quality of the forming of the supporting foot region can thereby be achieved.

The supporting foot forming region preferably has a bulged region which has an inner surface or contour corresponding to the above-described bulged region of the supporting foot of the plastic container (in particular according to a preferred embodiment). Preferably, at least one, preferably exactly one opening is arranged in the bulged region. The opening arranged in the bulged region is preferably arranged between the opening in the flattened region and a bottom center of the blow molding device (for producing the bottom center of the plastics preform) as considered in the radial direction (and/or along a shortest connecting line along the contour of the blow molding device). Two openings are preferably arranged in each case in the region of the blow molding device corresponding to the supporting region.

An opening designed as a slot can preferably open into the substantially circular opening arranged in the flattened region.

Preferably, the (in particular each) supporting foot forming region has a plurality, preferably more than 5, preferably more than 10, openings per side of the supporting foot. The plurality of openings are preferably each arranged in a supporting foot forming region which is designed to correspond to a region of the supporting foot arranged next to the supporting region of the supporting foot in or against the circumferential direction.

The plurality of openings can thereby be arranged in (substantially) within a common plane. In particular, the plurality of openings can be all openings of one side of a supporting foot forming region, which side is arranged, relative to the central axis of the blow molding device or of the plastic container to be produced therein, radially further outside than the flattened region and/or the bulged region.

The plurality of openings can be arranged in the form of one, two, three or more rows, wherein each row is formed by a plurality of openings.

Each row can follow a substantially rectilinear (approximately along a common plane) or a curved progression.

Complex series of tests by the applicant showed that a combination of this ratio between the surface of the bottom part and the surface of the openings (in particular all openings (in particular arranged in the bottom part)) (and/or an arrangement of the openings) and the flattened region already described as advantageous above can be achieved a reduction of the final blowing pressure to 7 bar. This offers substantial advantages for the energy and resource-saving production of plastic containers.

### BRIEF DESCRIPTION OF THE DRAWINGS

Further advantages and embodiments can be seen in the accompanying drawings:

In the drawings:

FIG. 1 shows a schematic representation of a plastic container;

FIG. 2 shows a representation of a progression in the region of a supporting foot of a plastic container according to the invention according to a preferred embodiment;

FIG. 3 shows a representation of a curvature progression in the portion shown in FIG. 2;

FIG. 4 shows a representation of a progression in a groove base of a preferred embodiment of a plastic container according to the invention;

FIG. 5-FIG. 10 show a bottom region 2 according to an embodiment from the prior art with curvature progressions each shown along different sectional curves;

FIGS. 11-13 show an illustration of a construction of a supporting foot 22 according to the invention and a bottom region resulting therefrom according to a preferred embodiment;

FIG. 14 shows a bottom region according to an embodiment of the present invention to represent curvature progressions;

FIGS. 15 and 16 show a sectional view through a corner region of a supporting foot according to the prior art and according to an embodiment proposed according to the invention of the supporting foot with a flattened region;

FIG. 19 shows an illustration of a construction of a supporting foot 22 according to the invention and a bottom region resulting therefrom according to a preferred embodiment;

FIG. 17, 18 show a transverse contour selected by way of example as a triangular shape for the construction of the flattened region with and without the resulting bottom region;

FIGS. 20-25 show in each case a bottom region according to an embodiment of the present invention to represent curvature progressions;

FIGS. 26-31 show representations, analogous to FIGS. 20-25, of curvature progressions of a bottom region according to the invention according to a second embodiment with a trapezoid as the transverse contour for the construction of the flattened regions;

FIG. 32 shows an alternative use of a trapezoid as a transverse contour;

FIG. 33 shows the trapezoid used in FIGS. 26-31.

FIGS. 34-36 show a relative geometric position of the flattened regions with respect to the supporting region, the groove base, and the turning point region together with the corresponding angular dimensions of a preferred embodiment;

FIGS. 37-39 show three-dimensional representations of bottom regions according to preferred embodiments;

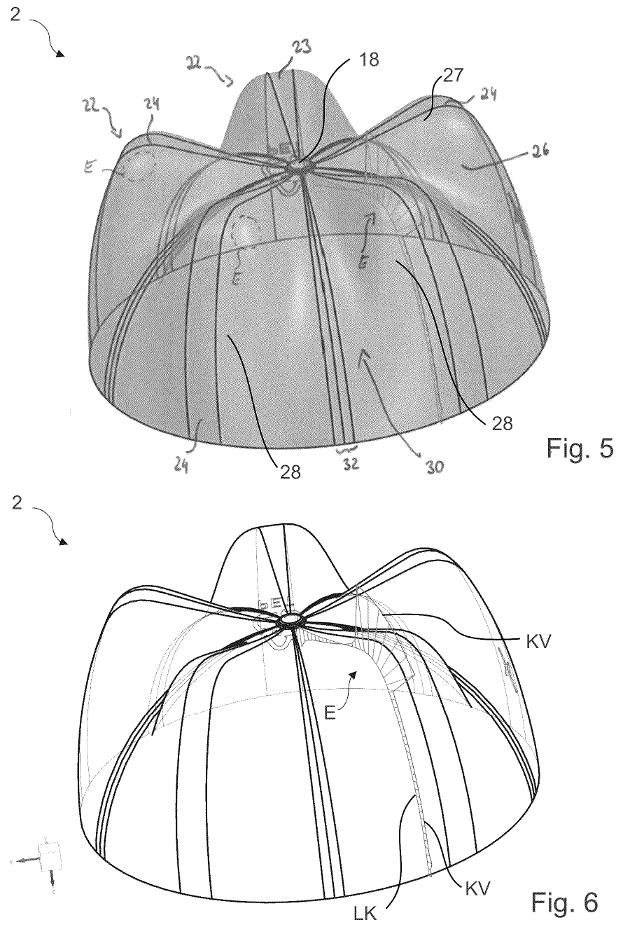

FIG. 40 shows an illustration corresponding to FIGS. 34-36 for a bottom region from the prior art, as shown by FIGS. 5-10;

FIGS. 41-48 show bottom lines of a bottom region according to the present invention in a preferred embodiment compared to a bottom line of a corresponding bottom region from the prior art;

FIGS. 45, 49 and 50 show a representation of sectional curves through the bottom region and bottom lines;

FIGS. 51 and 52 show a true-to-scale heat map representation of a surface curvature of the supporting foot in the region between the supporting region and the beginning of the groove base for a bottom region according to the prior art (FIG. 51), as described and illustrated, for example, in FIGS. 5-10, and for a bottom region 2 according to the invention according to the embodiment shown in FIGS. 20-25; and

FIG. 53-FIG. 60 show different preferred embodiments of a blow molding device according to the invention.

### DETAILED DESCRIPTION OF THE INVENTION

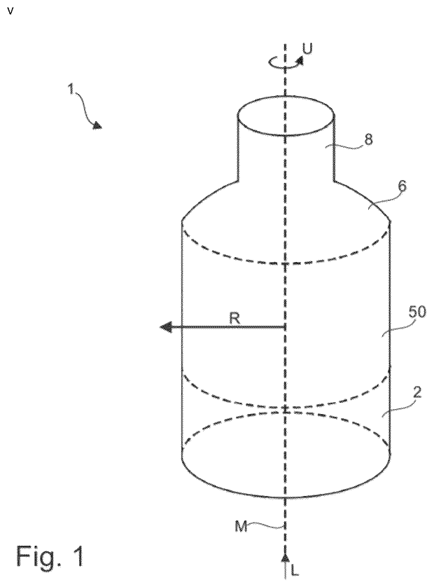

FIG. 1 shows a schematic illustration of a plastic container 1. This plastic container has a mouth region 6 with a container mouth 8 and a main body 50 adjoining the mouth region 6. Thereby, the main body 50 is used to hold the substantial filling volume. The shape of the main body can also be different from that shown in FIG. 1 and can, for example, have waves or patterns. Thereby, the mouth region 6 can have an external thread of the plastic container 1 and a support ring located at the container mouth 8. The container according to the invention also preferably has an external thread and a support ring.

The reference sign L designates a longitudinal direction of the plastic container 1. As illustrated, this is the longitudinal direction L and a direction along the central axis M of the container. A circumferential direction U, which is a direction of rotation about the central axis or longitudinal direction L as the axis of rotation, is also shown in FIG. 1.

A bottom region 2 of the plastic container 1 adjoins the main body 50, wherein the main body 50 can merge into the bottom region 2 via a curved section or via a non-curved section.

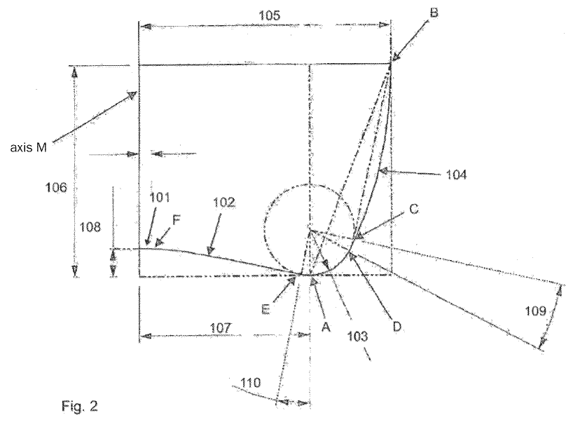

The reference sign 22 designates a supporting foot (not shown here) of the container (see, e.g., FIG. 2). The bottom region 2 can have several supporting feet 22 that allow it to stand upright on an even surface. The reference sign R refers to a radial direction relative to the central axis M or to the longitudinal direction L of the plastic container. Thereby, the radial direction R is perpendicular to the central axis M and the longitudinal direction L and either runs towards them or away from them towards the outside. In particular, the main body 50 is formed by or has a side wall. Such side wall extends fully in the circumferential direction U of the container.

FIG. 2 shows a representation of a preferred bottom portion in the region of a supporting foot 22. More precisely, the line shown in FIG. 2 illustrates the progression in the region of the supporting foot. In this case, the base contour in this foot region is first described by a straight line 101, which is adjoined by a spline or curved portion 102. Such curved portion 102 is preferably followed by a further curved portion or spline 103, and by a further curved portion 104, with which the bottom region merges into the main body 14. From this contour shown in FIG. 2, the foot surface can, as explained in more detail below, be created by a rotation of the bottom geometry about the axis of rotation M (which also defines the geometric center of the bottom portion).

The transitions from the straight portion 101 into the curved portion 102 in the point F and/or the transition from the curved portion 102 into the foot radius 103 into the point E shown are preferably tangentially-continuous. The position of the point E can be controlled by the angle 110 on the foot radius of the portion 103. Preferably, the transition to the curved portion or spline 104 is also tangentially-continuous, particularly preferably curvature-continuous. The curved portion 104 preferably merges tangentially-continuously and particularly preferably curvature-continuously into the main body or the outer diameter of the container.

The curvature progression of this curved portion 104 can be described by a polynomial of the nth degree.

The outer dimensions of the bottom portion are determined by the outer diameter or radius 105 and the bottom height 106. The dimension of the pitch circle diameter or radius 107 is preferably defined by a ratio to the outer diameter 105. The height of the straight line 108 is preferably described by a ratio to the outer diameter 105.

The starting point D of the curved progression 104 is created here by a straight line between the point B and the point C. This straight line BC is advantageously arranged tangentially on the foot radius. The starting point D of the curved portion 103 can in turn be determined using the angle 109 on the foot radius of the portion 103 between the points A and C.

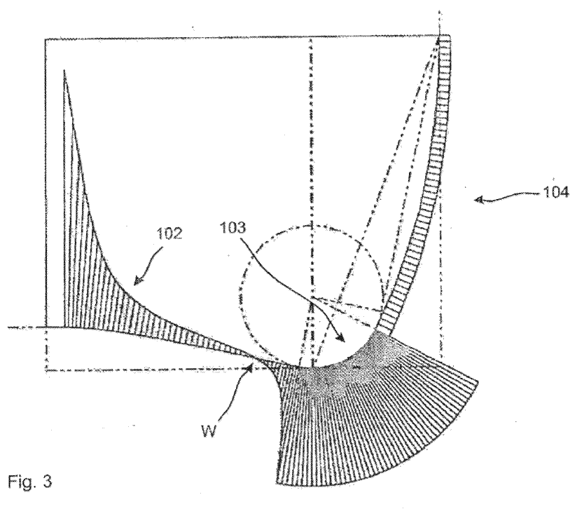

FIG. 3 shows a progression of the curvature of the portion shown in FIG. 2. It can be seen that the region 102 is curved in a first direction and the region 103 is curved in a second direction. A turning point W, in which point the curvature changes, is located between these two regions. It can also be seen that the curvature in the region 103 is stronger than in the region 104. The corresponding straight lines extending away perpendicularly to the line indicate a measure of the inverse curvature, i.e. the longer the corresponding lines, the greater the radius of curvature also and the smaller the curvature. The entire progression of the bottom portion resulting from the portions 102, 103 and 104 thus has only one turning point.

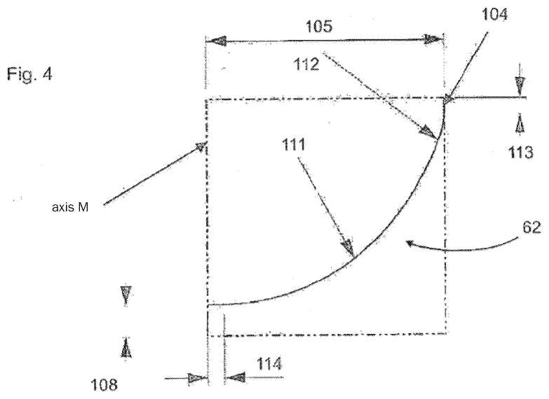

FIG. 4 shows a preferred progression in the region of a groove base 62 or tension band. In this region, the contour is again first described by a straight line 114 and the adjoining large tension band radius 111, a region which preferably has a constant curvature. A region 112 with a smaller tension band radius adjoins this region 111. In turn, a part 113 in which the progression can also be rectilinear adjoins this region. In turn, the base contour of the foot and the transition into the main body adjoin this region 113. As shown in more detail below, the tension band surface is also created from this shown contour by a rotation about the axis of rotation M. Advantageously, the transitions between the region 111, the region 112, the part 113 and the base contour 104 are also tangentially-continuous here.

FIGS. 5 to 10 show a bottom region 2 of a plastic container 1 according to an embodiment from the prior art with curvature progressions KV, each shown along different sectional curves. These are in each case the same bottom region 2 designed as a petaloid bottom, which is used, for example, for carbonated beverages.

FIGS. 5 and 6, FIGS. 7 and 8 and FIGS. 9 and 10 show—for better understanding—the same curvature progressions running along a corresponding sectional curve, in each case in pairs, once in a three-dimensional grayscale image and once in a pure line representation.

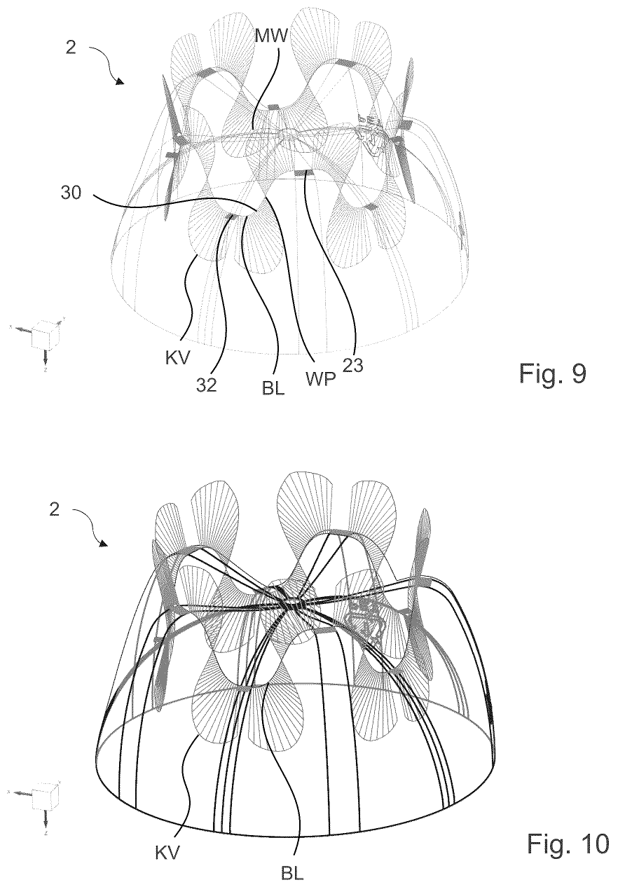

As shown in FIG. 9, the bottom region shown here by way of example has five supporting feet 22 which each have a supporting region 24 extending substantially from the bottom center 18 to the boundary of the bottom region to the main body. The supporting region 24 has an, in particular substantially flat, supporting surface 23, which a supporting plane on which the plastic container 1 stands upright on its supporting feet 22. The bottom center (typically an injection point of the plastic container 1) is thereby spaced apart from the supporting plane by a so-called bottom clearance.

A groove 30, in which the bottom region 2 extends comparatively further in the direction of the container interior, is arranged between each two supporting feet 22. It can also be seen in FIG. 5 that the bottom region 2 is bulged inward or concavely curved in the groove (at least in portions), while the bottom region (except in a region around the bottom center 18 (in particular in both main directions of curvature in each case) is bulged outward or convexly curved.

There is therefore a turning point region (denoted in the following figures with the reference sign W) between a supporting foot 22 and an adjacent groove, in which turning point region the orientation of the curvature of the bottom region (at least in a main direction of curvature) is reversed.

The reference sign 32 designates a groove base of the groove 30 which is arranged in the geometric center of the groove and which is designed in such a way that it acts as a tension band which transmits forces acting on the bottom center 18 to the main body. For this purpose, it preferably substantially has a hemispherical (or ellipsoidal) progression (within an angular segment defined in the circumferential direction).

The reference sign 26 designates a foot side region 26 which represents a lateral region of the supporting foot 22. This is in particular mainly facing toward the adjacent supporting foot 22. A main direction of extension of the corresponding normal vector of surface points of this foot side region 26 runs in (or counter to) the circumferential direction U.

The reference sign E designates a corner region of the supporting foot 22. In this corner region, a foot outer region 28, a region facing (mainly) outwards (in the radial direction), a foot lower region 27 facing (mainly) downwards (in a state standing upright on the supporting feet) meet each other. This corner region is arranged between the foot side region 26 and the supporting region. In other words, the corner region serves as a type of transition region of the supporting region 24 into the foot side region 26. In an analogous manner, the corner region E serves to transfer the foot outer region 28 into the foot side region 26.

A preferred example of a plastic container with a bottom region 2 according to FIGS. 5-10 could have a diameter of 100 mm. The pitch circle diameter could be 64.5 mm. The bottom clearance, measured from a contact surface/supporting plane to the bottom center/injection point, amounts to 5.507 mm in this example.

Identical reference signs subsequently designate identical or similarly acting and/or designed regions or features.

FIGS. 5 and 6 show the curvature progression KV of the bottom region along a longitudinal sectional contour LK which results from a longitudinal section of the bottom region 2 through the corner region E, wherein the longitudinal section takes place along a plane in which the central axis M lies. The longitudinal sectional contour LK does not have any extension in the circumferential direction U.

The curvature progression along this longitudinal sectional contour shows that the bottom region is bulged inward in a region around the injection point or the bottom center 18. Radially further outward, i.e. with increasing distance from the central axis M, the orientation of the curvature reverses in an outwardly bulged or convex curvature. In particular around the corner region E, the bottom region is convexly curved along the longitudinal sectional contour. In this case, the amount of curvature increases greatly in the region of the corner region E and initially decreases slightly in the corner region and rapidly after the corner region. In the upper foot outer region, viewed in the longitudinal direction L, the bottom region has only a small (convex) curvature along the longitudinal sectional contour LK. It can also be seen that within the corner region E and in the portion of the longitudinal sectional contour LK adjacent to the corner regions E in the radial direction, the amount of curvature and/or the curvature value decreases continuously, but compared to the regions adjacent thereto, the longitudinal sectional contour does not have a local minimum of the amount of curvature and/or curvature value in a portion lying within the corner region E.

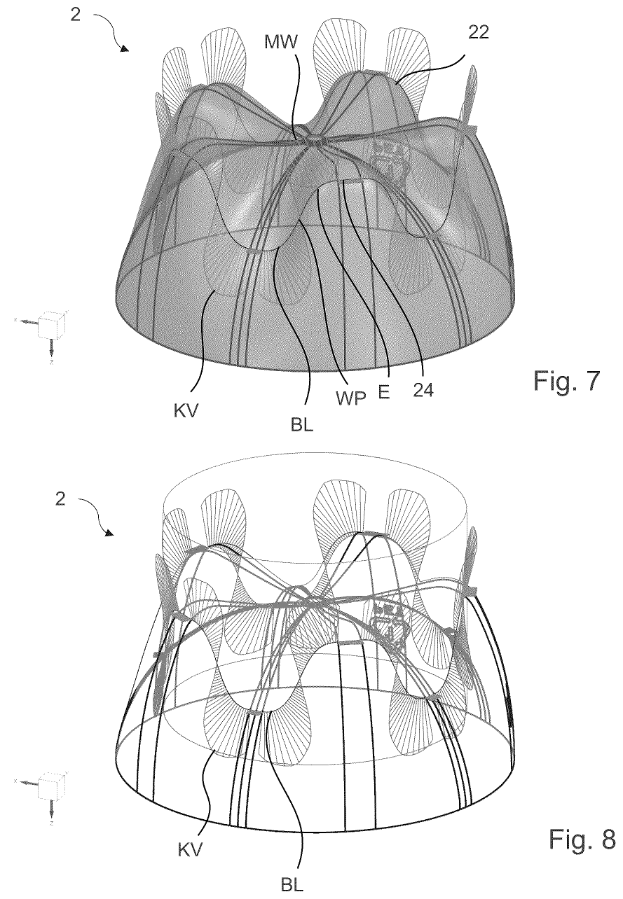

FIGS. 7 and 8 show the curvature progression along a bottom line BL through the corner region E and the supporting region 24 of a supporting foot 22. A bottom line is understood here (and below) to mean a contour resulting from a cylindrical section with the bottom region or a line that follows this contour on the outer surface.

In a projection onto the supporting plane along the central axis, the bottom line represents a circular line.

In the bottom line selected in FIGS. 7 and 8, a diameter of this circle of 77 mm was selected for the preferred example, described above, of a container with this bottom region.

In an alternative definition, the bottom line describes a line progression which follows the bottom region (or its outer surface) and which always has the same distance from the central axis.

In this case, the curvature progression of the bottom line refers (also following) in particular (also following) to the bottom line BL that is unwound (along the cylinder lateral surface), so that the shown curvature progression reflects exclusively a curvature progression of the height values of the bottom region as a function of a circumferential angle (measured in the circumferential direction).

The height values are measured (exclusively) along the central axis by projecting the corresponding point of the bottom line onto the central axis in exclusively the radial direction.

For example, the height values are measured as a distance of the corresponding point of the bottom line from a plane running perpendicular to the central axis, which plane, for example, goes through the container region in which the bottom region merges into and/or adjoins the main body.

As can be seen from the curvature progression (shown in a curvature value representation running perpendicular to the bottom line), the bottom region is not curved along the supporting region 24 (has the same height value and moves along a circular line). The bottom line BL runs accordingly within the supporting region 24 on a circular line. Adjacent to the supporting region 24, the curvature value initially increases abruptly, continues to increase continuously within the corner region E until a maximum MW (of the amount of curvature or curvature value) is reached, and then decreases continuously until a turning point WP is reached, in order then to change the orientation of the curvature after reaching the turning point WP within the groove 30. The turning point WP represents the delimitation between the groove region 30 and the supporting foot 22

It can be seen that exactly one maximum value is reached within the corner region E of the curvature progression along the bottom line BL, which maximum value simultaneously represents the (global) maximum of the curvature values and/or amounts of curvature of the entire bottom line along the portion between the supporting region and the turning point WP.

FIGS. 9 and 10 each show two slightly different perspective representations of the bottom region with a bottom line BL, which likewise runs through the corner region E and the supporting region 24, but here additionally through the supporting surface 23.

In the exemplary preferred container mentioned above, this bottom line (in the projection described above) has a circle diameter of 64.50 mm.

The bottom line BL running through the supporting surface 23 shows a similar curvature behavior as the bottom line BL selected in FIGS. 7 and 8.

The non-bulged region within the supporting surface 23 (curvature value is zero), the abrupt increase of the curvature value in the portion of the bottom line BL adjacent to the supporting region, here the supporting surface 23, in the supporting foot 22, can again be seen. Again, the amount of the curvature value or the curvature value increases until a (precisely one) maximum value MW is reached within the corner region E and then decreases continuously until the turning point WP (curvature value is zero here) is reached.

The turning point WP represents the delimitation between the supporting foot 22 and the groove 30.

In the groove, the amount of the curvature value increases again continuously until a maximum amount of curvature is reached (minimum curvature value, since negative curvature values) and the bottom line following further in the direction of the groove base 32, the amount of the curvature value decreases again here continuously. A decrease, in this case abrupt, in the amount of the curvature value during the transition to the groove base 32 is conceivable. As shown in FIGS. 7-9, a groove base which has a non-curved bottom line within the groove base is conceivable. However, other embodiments of a groove base are also conceivable, for instance with different regions bulged inward and outward.

Here too, a minimum amount of the curvature value and/or local curvature value minimum within the bottom line running between the supporting surface 23 and the turning point WP is not assumed in the corner region.

The two laterally arranged corner regions E of the supporting feet 22 thereby represent the most challenging region during forming in the blow molding process. A good ability to be formed can only be achieved with this base design by applying a very high final blowing pressure.

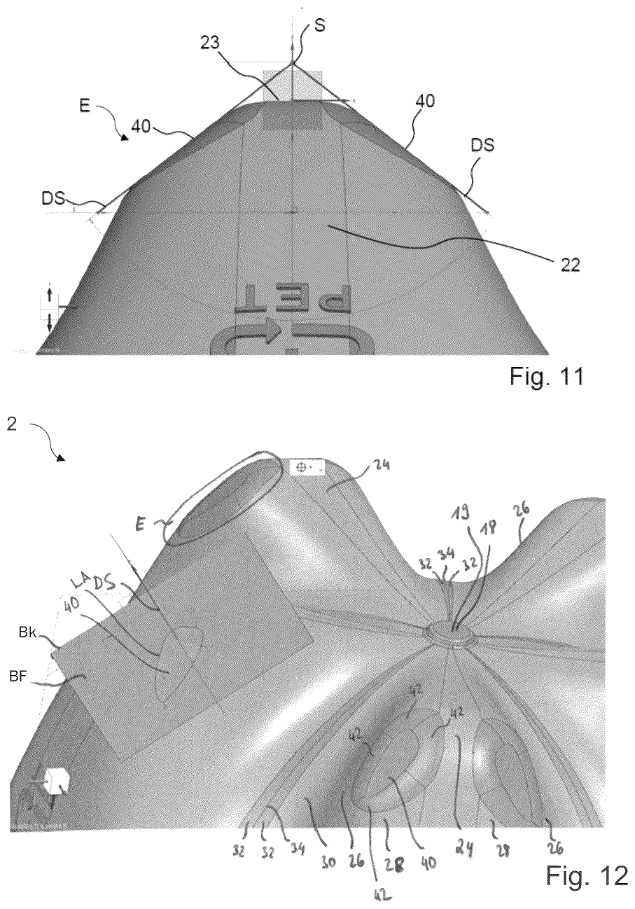

FIGS. 11 to 13 each show an illustration of a construction of a supporting foot 22 proposed according to the invention (FIGS. 11, 12) and a bottom region 2 (FIG. 12) resulting therefrom with several supporting feet 22 according to the invention, according to a preferred embodiment. Both figures show a view from the outside of the centrally shown supporting foot 22 in a different perspective representation.

As can be seen from FIGS. 11-13, the previous bottom progression of the supporting foot 22 is flattened in the two corner regions E, arranged laterally to the supporting region or to the supporting surface 24, of the supporting foot 22 in that a flattened region 40 is provided in each case. In the embodiment shown in FIGS. 11-13, this flattened region 40 is even. A bulged region 42 is provided around the flattened region 40 and transfers the bottom progression of the supporting region into the bottom region of the groove or the remaining foot side surface 26.

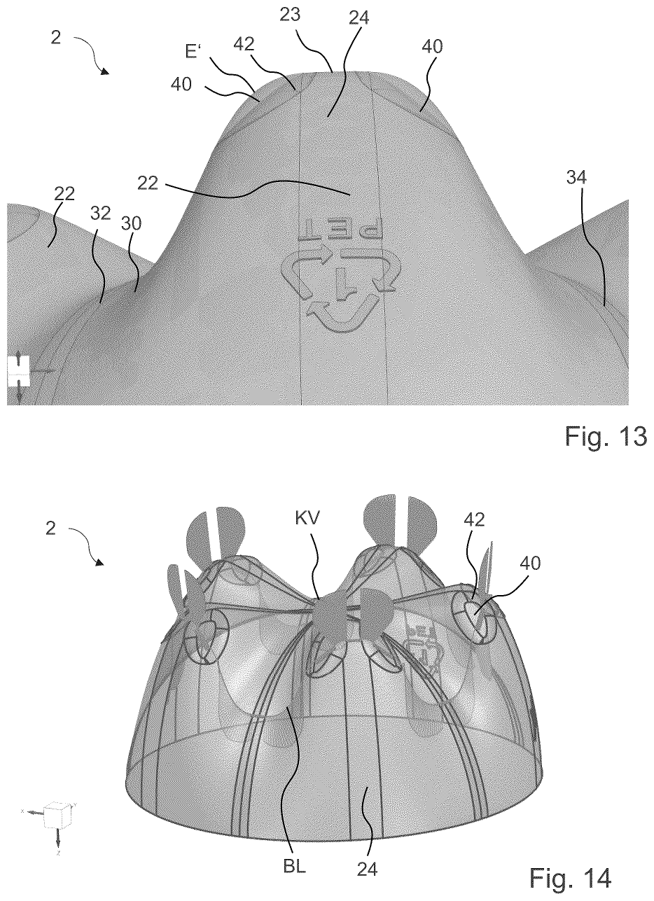

FIG. 13 shows a comparison between the previous bottom progression of a supporting foot with the embodiment, changed according to the invention, of a bottom progression of a supporting foot 22. In this case, preferably exclusively the two corner regions E of the supporting foot are changed. For better distinction, the corner region of the supporting foot from the prior art, which has been shown and described in FIGS. 5-10, is designated with the reference sign E′ and shown transparently.

It can be seen that the flattening of the corner region E of the supporting foot caused by the provision of the flattened regions 40 causes the bottom progression to decrease more quickly in the corner region in the direction of the groove base 32 and/or the groove 30. The reference sign 34 designates the geometric center of the groove base 32, which usually also forms the geometric center of the groove 30.

In complex experiments, the applicant has found that a supporting foot flattened in this way requires a significantly lower final blowing pressure in order to nevertheless ensure good ability to be formed of the corner regions E of the supporting foot.

The two FIGS. 11 and 12 illustrate a construction of the flattened region 40. Preferably, except for the flattened region and the bulged region, all further regions of a (petaloid) bottom known from the prior art, in particular of the bottom regions 2 described and shown in FIGS. 5-10, remain unchanged.

For the construction, a transverse contour is preferably used, which is given here by an isosceles triangle with tip S and the two legs DS (described above as variant Z). The opening angle of the triangle at the tip S can be between 45° and 179°, preferably between 80° and 150°. In the example shown, the opening angle is 105°. The height (of the tip S above the supporting region) is preferably between 2 and 50 mm.

Further preferably, a guide contour is used to construct the flattened region. The guide contour preferably runs in a plane in which the geometric center of the supporting region 24 and/or of the supporting foot 22 runs. In FIG. 11, the guide contour runs through the tip of the triangle S and runs perpendicular to the figure plane.

For example, the above-described variants A or B can be used as guide contours. The guide contour is preferably designed on the center of a foot, particularly preferably with the aid of the sectional contour.

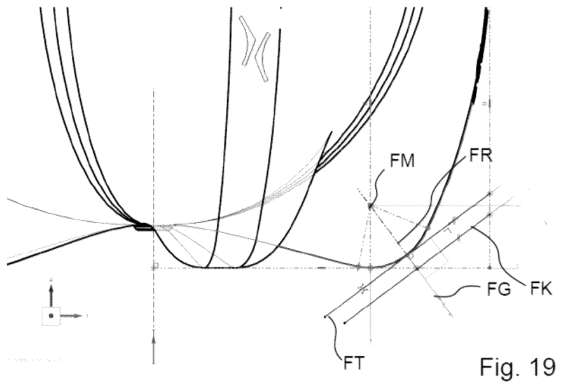

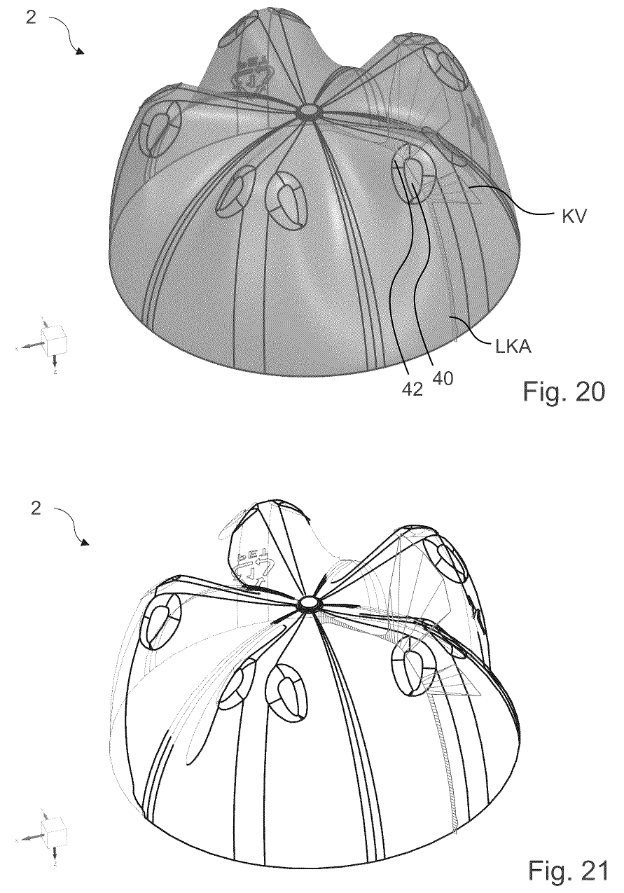

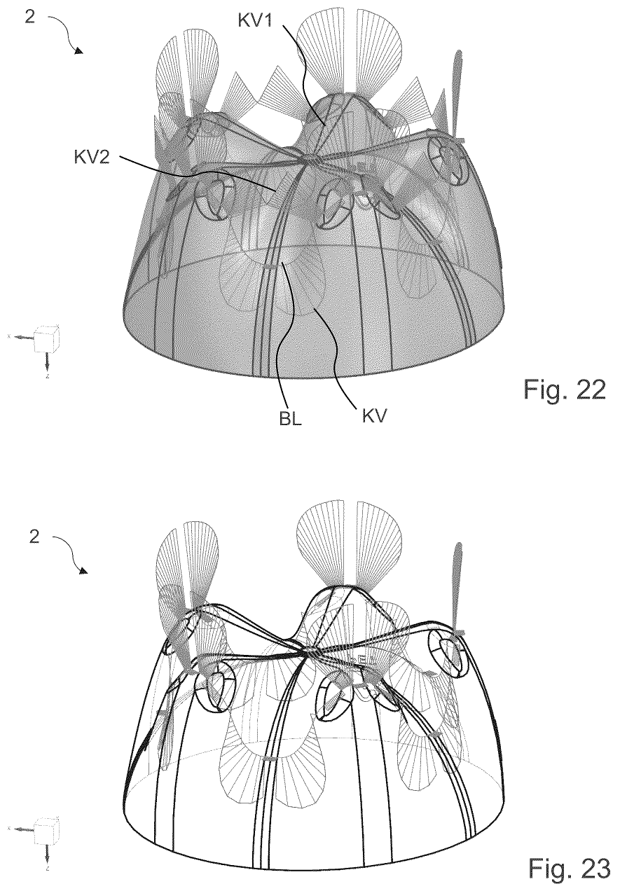

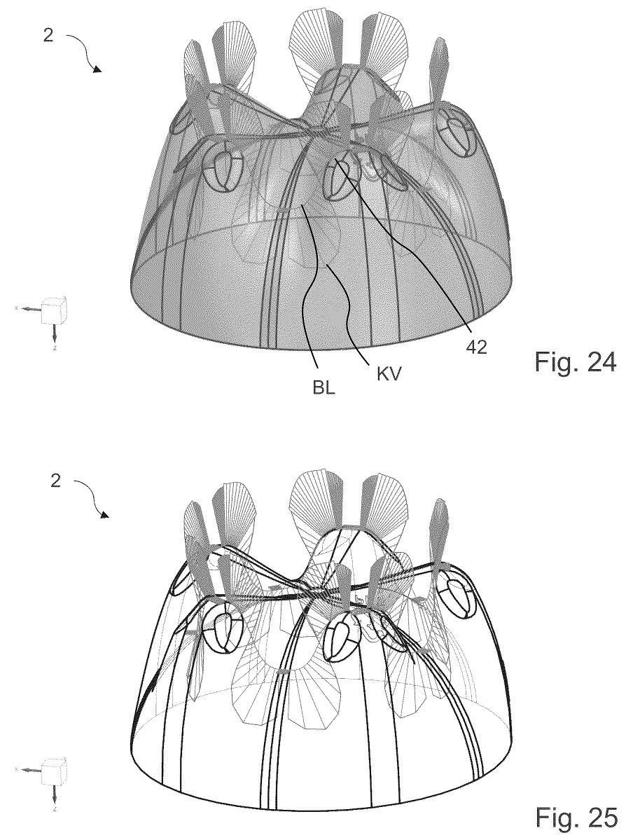

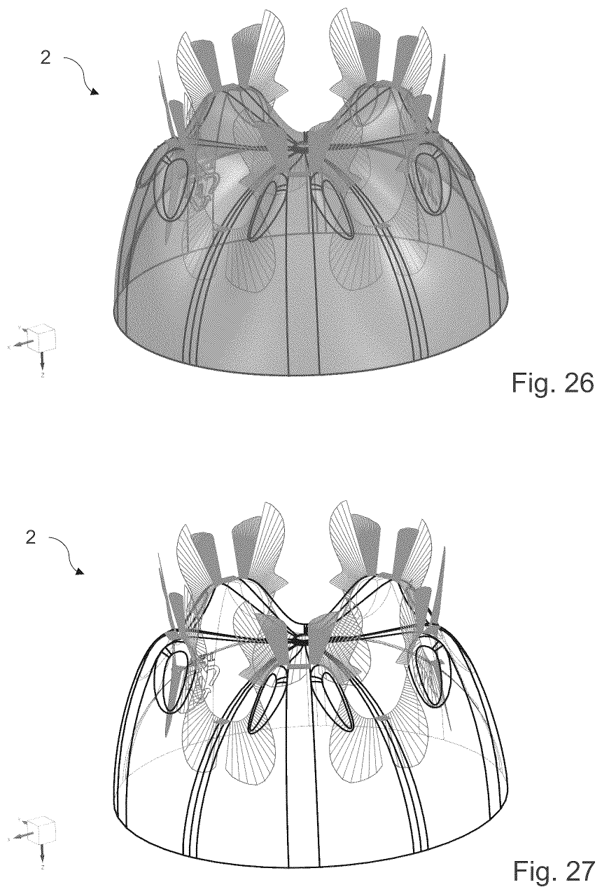

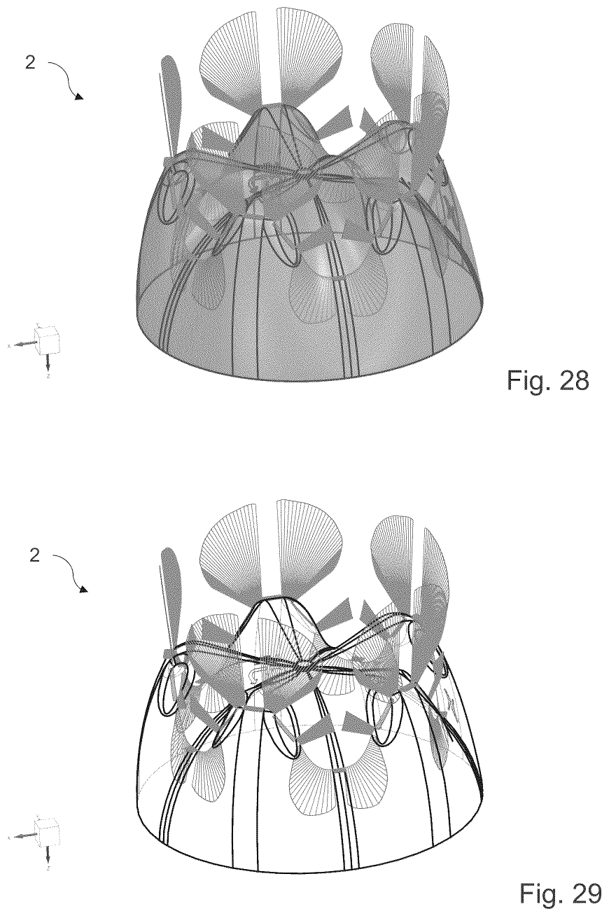

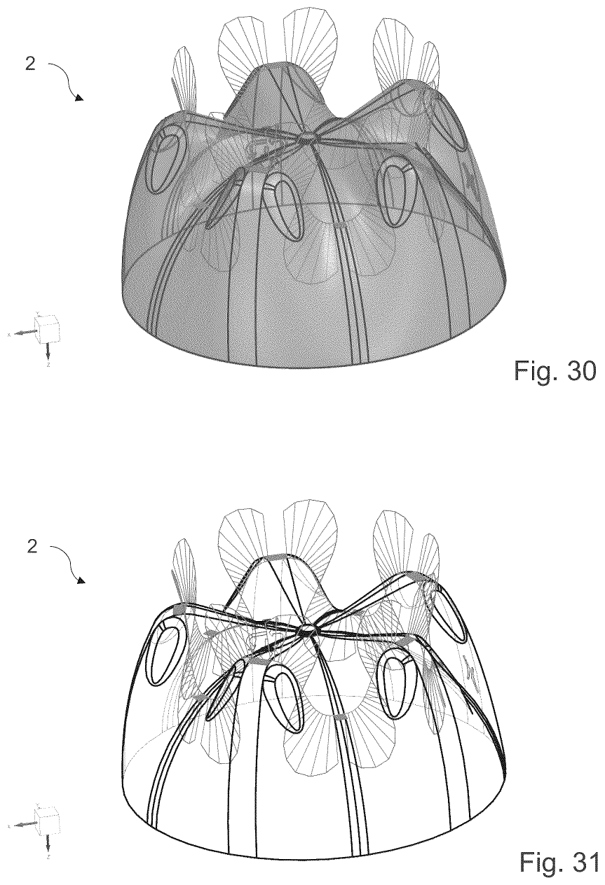

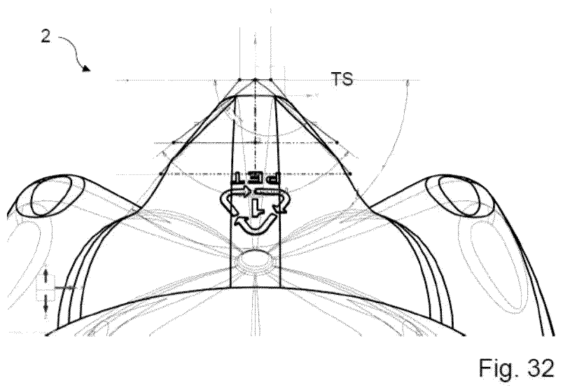

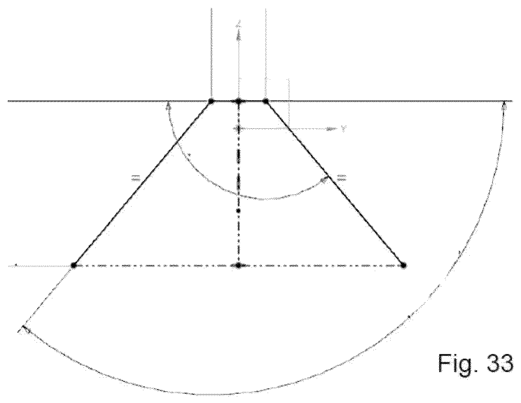

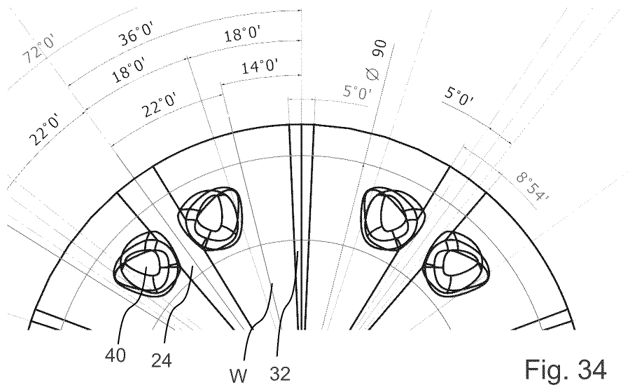

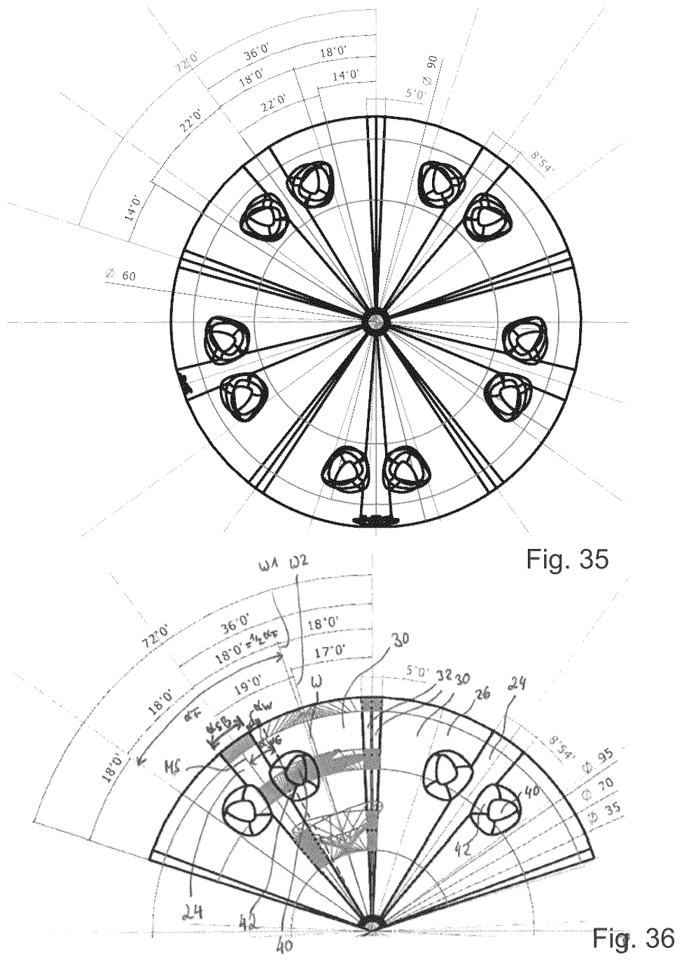

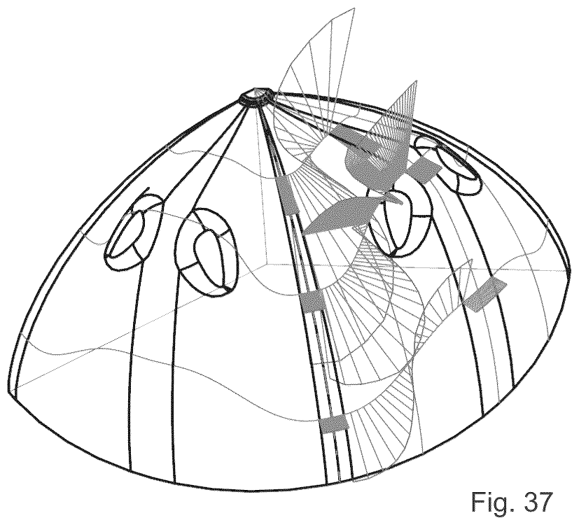

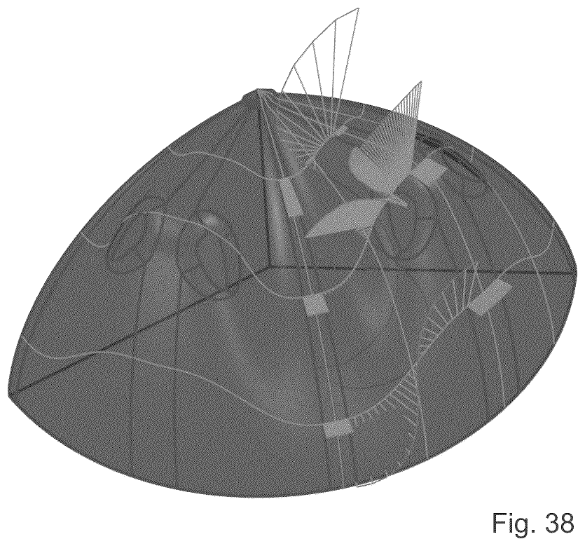

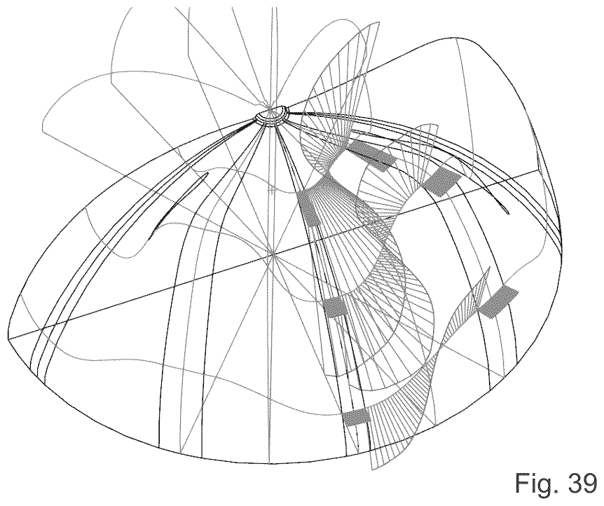

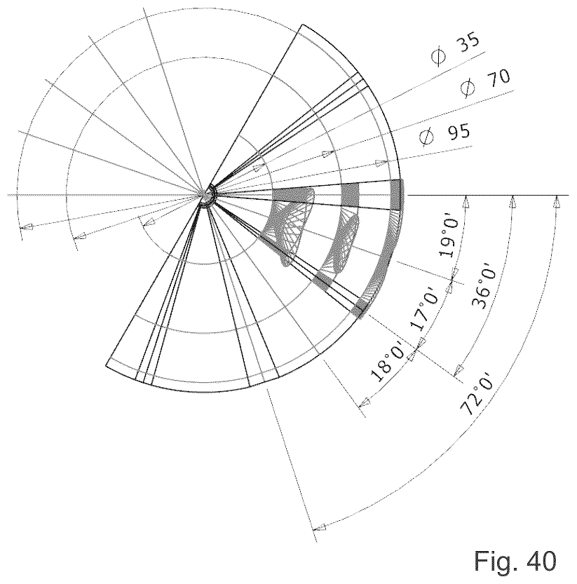

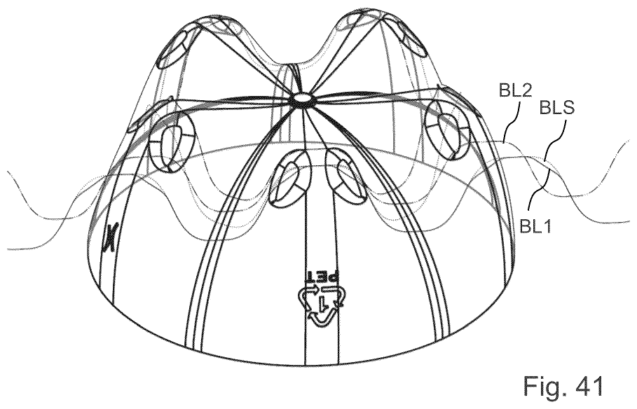

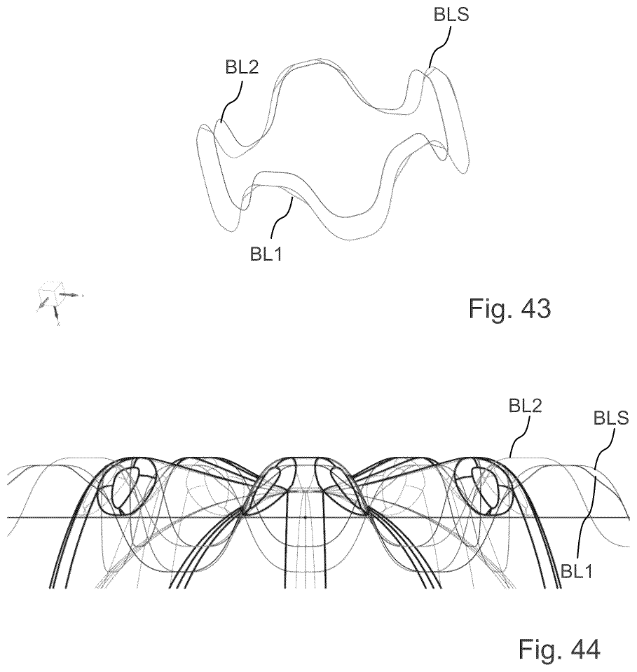

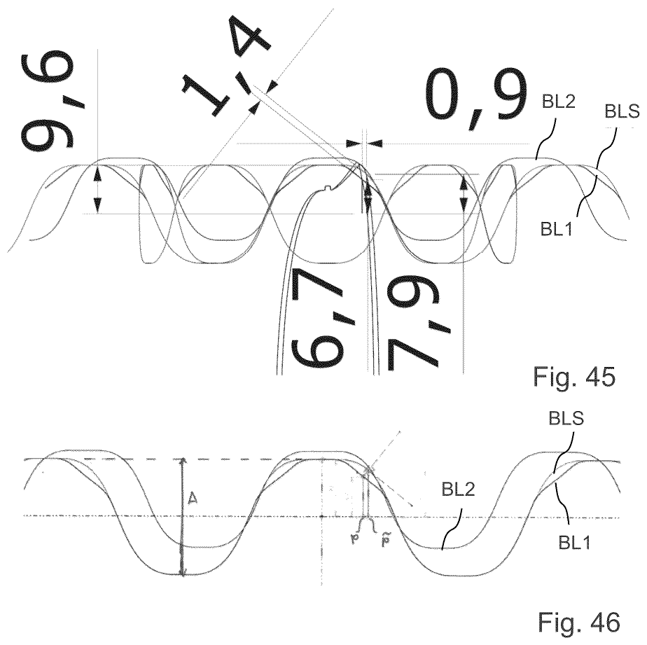

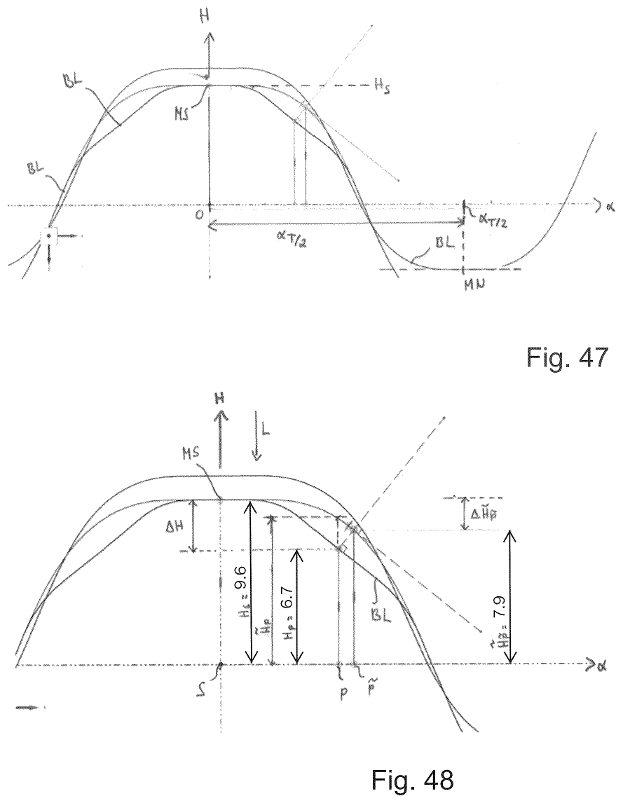

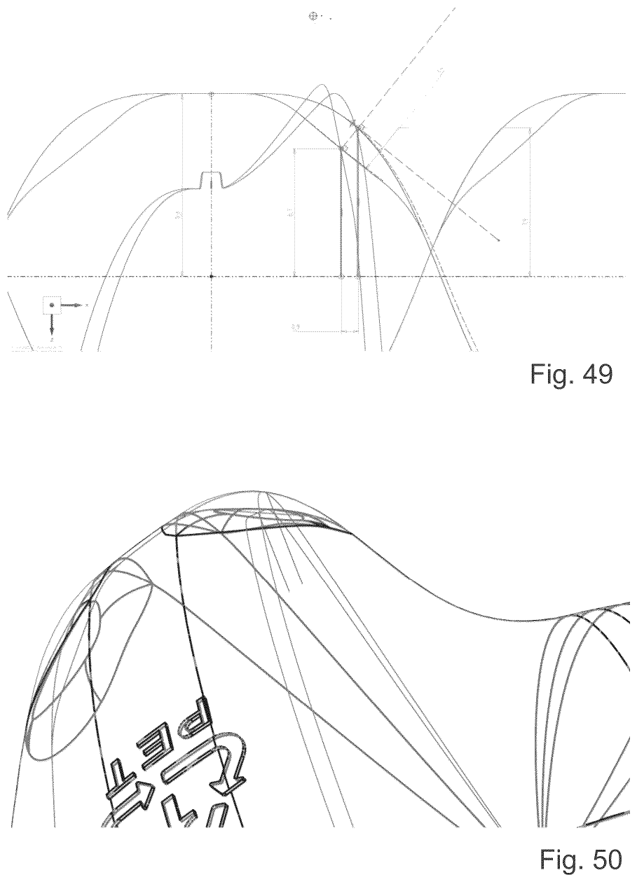

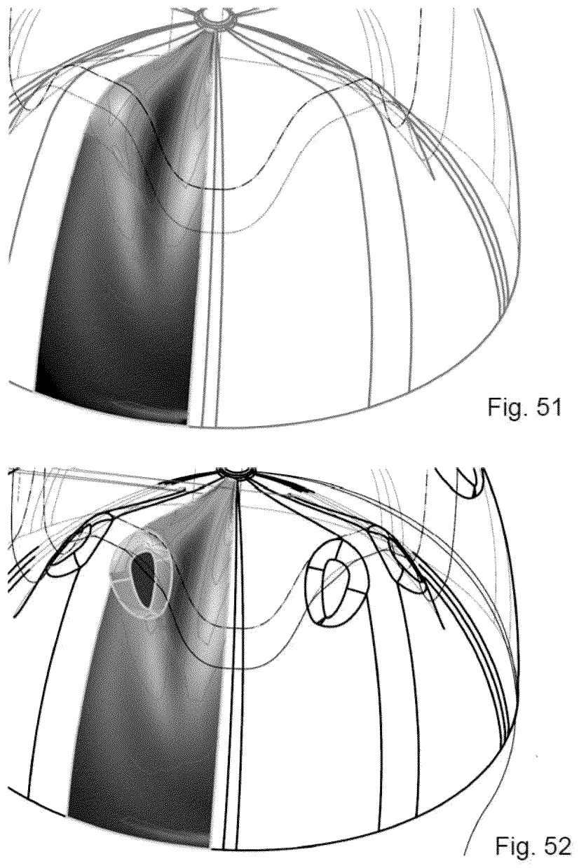

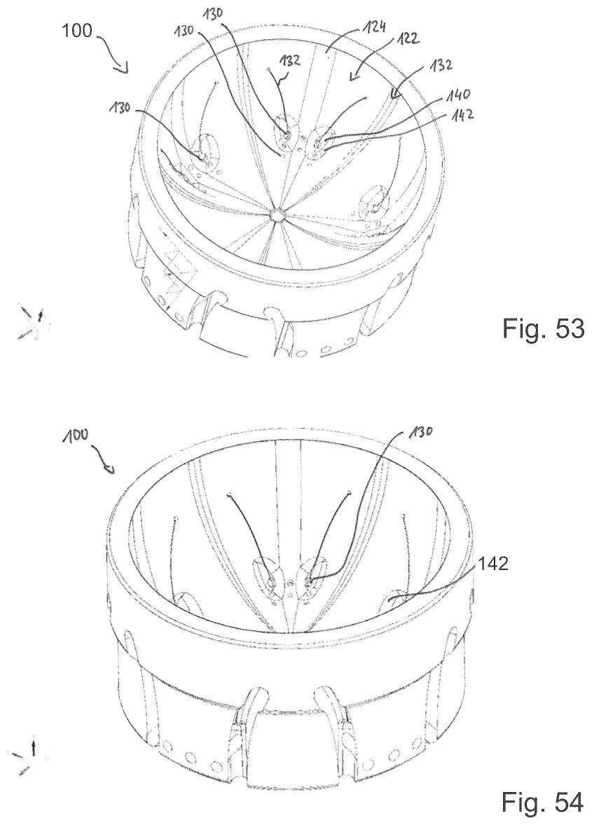

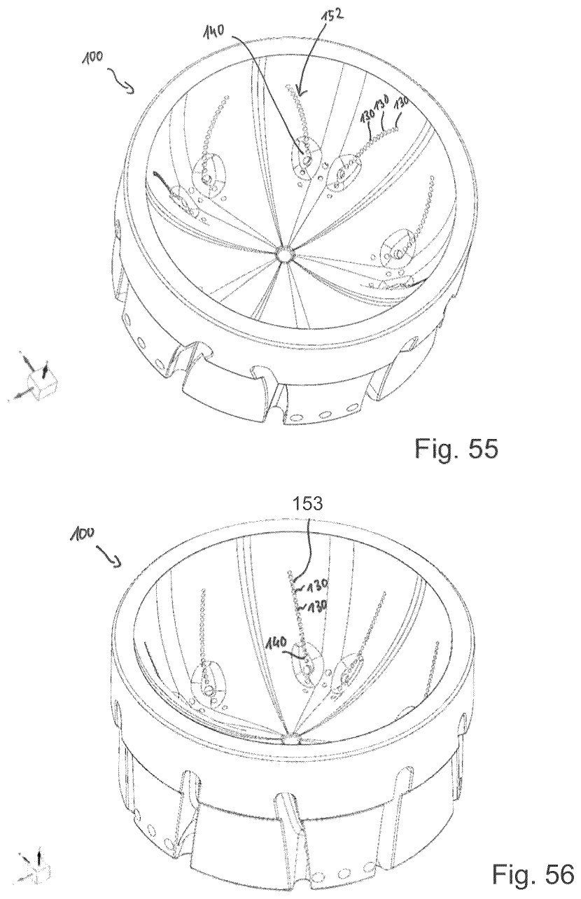

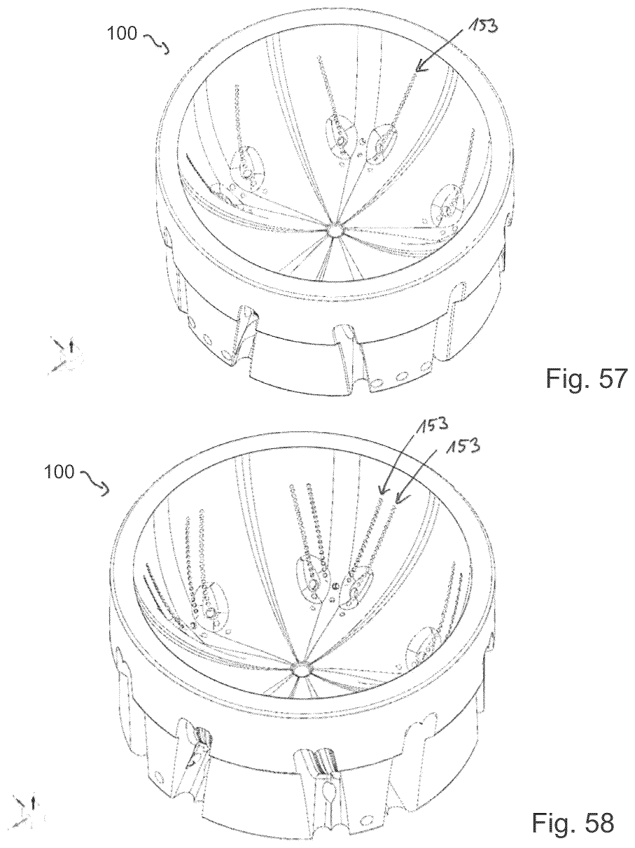

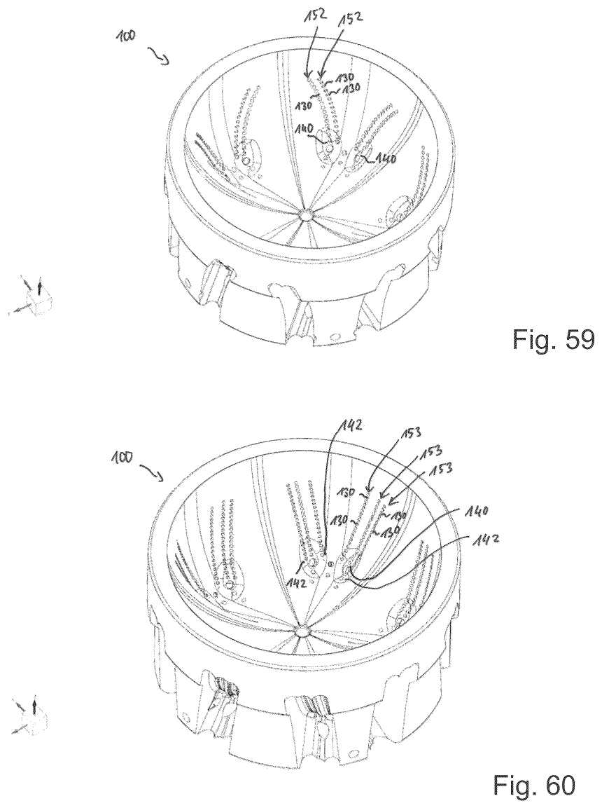

In FIG. 19, steps for the construction of the guide contour are explained by way of example.

For example, a perpendicular is constructed on the radius FR of the (supporting) foot 22 in order to generate the guide contour with the aid of a straight line. The reference sign FM designates a center point of the circle with radius FR, which follows a cross-sectional contour of the foot at least in portions. The straight line is controlled by an angle. The angle moves between the perpendicular through the center point of the foot radius to the supporting surface and the straight line. The values are between −30° and 80°, preferably between −10° and 65°.

The reference sign FG designates a straight line which runs along a radius FR. The straight line FG selected here encloses an angle of 36.7° with the longitudinal direction L. Angles between 10° and 50°, preferably between 30° and 40°, are conceivable.

A tangent FT is further created perpendicular to the straight line. Parallel with the tangent, a straight line FK is created as a guide contour at a distance (which is selected in the example shown as 2.5 mm). The distance ranges between 0 and 20 mm, preferably between 2 and 10 mm. The length of the straight lines can be defined.

In FIG. 12, the edge marked with the reference sign BK is the guide contour. The transverse contour, here an isosceles triangle, is guided along this edge, so that here, considered on both sides of the supporting foot 22, a sectional surface with a surface progression BF results, which results in the book covers of a book cover BF opened with the opening angle of the triangle.

The guide contour, in particular a distance of the guide contour from the supporting region, and/or the transverse contour, in particular an opening angle of the transverse contour, as here an opening angle of the triangle, is in particular selected such that a sectional contour LA with the surface progression BF results in the corner region E of a supporting foot. This sectional contour LA preferably forms a boundary line of the flattened region 40 constructed therefrom. The flattened region 40 can be given by the inner surface of the sectional contour LA lying in the sectional surface BF.

Depending on the selected transverse contour and/or guide contour, a flat progression of the flattened region 40 (triangle as transverse contour and straight line as guide contour) or a curved progression of the flattened region (e.g., by a parabolic progression of the transverse contour) results from a flattened region 40 selected as a sectional region.

The bulged region 42, which here completely surrounds and/or adjoins the flattened region 40, results from a rounding of the bottom region at the transition edge of the sectional surface and of the surrounding bottom region.

FIGS. 17 and 18 again show the transverse contour used (in FIGS. 11-13) (FIG. 17 together with the produced bottom region with the flattened region 40 according to the invention according to an embodiment), which has here, for example, a triangular geometry.

The height of the triangle can be 10 mm, for example, for the container dimensions mentioned by way of example above.

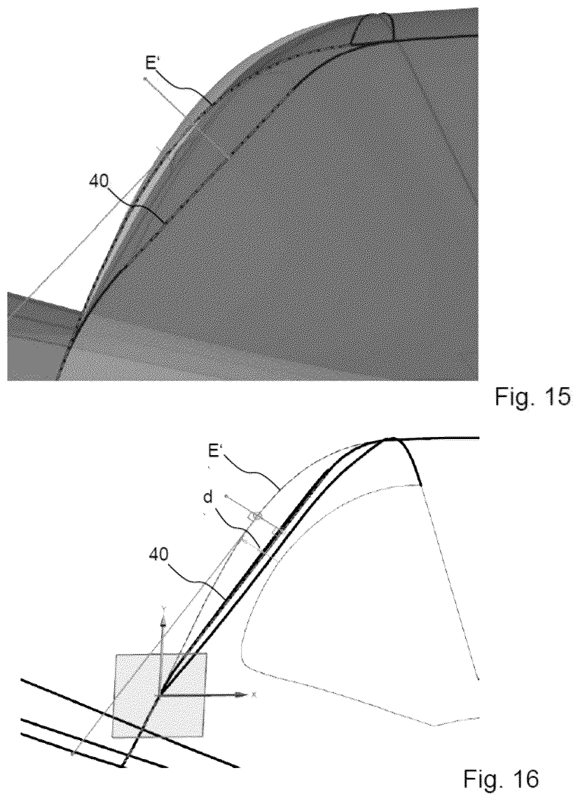

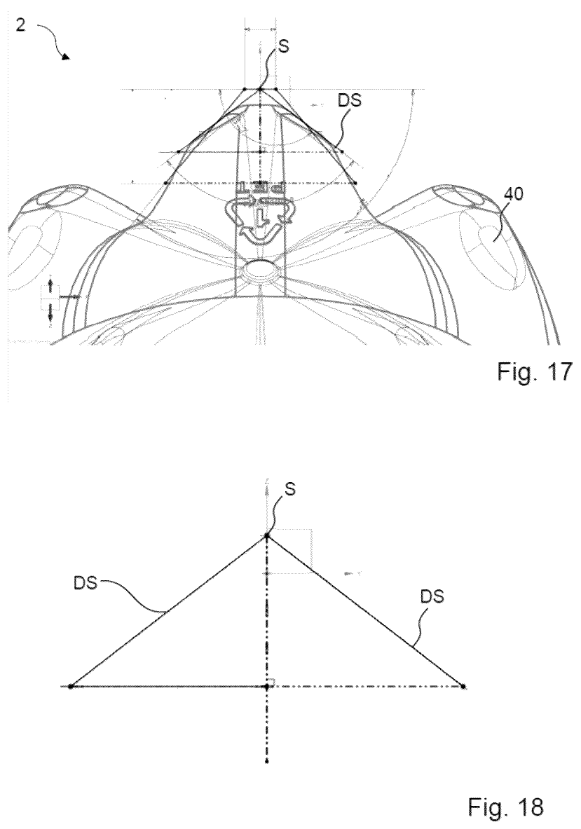

FIGS. 15 and 16 each show a sectional view through a corner region E′ of a supporting foot 22 according to the prior art and according to an embodiment proposed according to the invention of the supporting foot with a flattened region 40. A triangle was used in FIG. 15 as a transverse contour and a trapezoid was used in FIG. 16 as a transverse contour to construct the flattened region 40. The reference sign d designates a distance between the corner region E′ of the prior art and the flattened region 40 of the embodiment according to the invention.

FIGS. 14, 20-25 each show a bottom region 2 according to an embodiment of the present invention to represent curvature progressions. These correspond to the curvature progressions of a corresponding bottom region according to the prior art shown in FIGS. 5-10.

Those in FIGS. 14, 20-25 have an even flattened region 40, which can be constructed, for example, with a triangular contour as a transverse contour.

FIGS. 14, 22, and 23 show slightly different perspective views (FIG. 14) or a representation in pure dashed lines (FIG. 23) of a curvature progression along a bottom line BL which extends through the supporting region 24, namely through a region of the supporting region 24 which lies further outside the supporting surface 23, as viewed in the radial direction. In particular, the bottom line shown here runs through the flattened region 40 and the bulged region 42 adjacent thereto.

When it is projected onto a plane running perpendicular to the central axis, the bottom line shown in the example has a circle diameter of 77 mm for the exemplary container described in the context of FIGS. 5-10 with the now modified bottom region according to the invention.

The supporting region and the groove as well as the groove base are designed unchanged in relation to the bottom regions 2 shown in FIGS. 5-10, so that the curvature behavior KV of the bottom line BL is identical in these regions.

In contrast, a changed curvature behavior KV of the bottom line BL is now present in the corner region E. During the transition from the supporting region 24 to the bulged region 42, an abrupt increase in the curvature value (and the amount of curvature) KV takes place, which then continuously decreases until the flattened region 40 has been reached. There is no curvature in the latter, which is why the curvature value is zero. After the portion of the bottom line BL running in the flattened region, the bottom line passes through a further portion of the bulged region 42, which in this case surrounds the full circumference of the flattened region 40. In this region, the bottom line is curved again, wherein the curvature has the same orientation as in the portion of the bulged region 42 between the flattened region 40 and the supporting region 24.

In particular, FIG. 22 shows that both the curve progression KV1 in the portion of the bulged region 42 which is arranged (in the circumferential direction U) between the flattened region 40 and the supporting region 24 and the curve progression KV2 in the portion of the bulged region 42 which is arranged (in the circumferential direction U) between the flattened region 40 and the adjacent groove and/or groove base assume a maximum value which is greater than a maximum value of the amount of curvature or curvature value within the flattened region 40.

The two FIGS. 24 and 25 show a corresponding curve progression KV for a bottom line BL which runs through the supporting surface 23 and an outer edge of the bulged region 42, but not through the flattened region 40.

When it is projected onto a plane running perpendicular to the central axis, the bottom line shown in the example has a circle diameter of 64.50 mm for the exemplary container described in the context of FIGS. 5-10 with the now modified bottom region according to the invention.

In the outer edge, the bulge progression already substantially again assumes the curvature progression of the bottom region according to the prior art, which is why the curvature progression KV of the bottom line BL here has a curvature progression corresponding to FIGS. 9 and 10 with (between the supporting region 24 and the turning point WP) only one occurring maximum curvature value or amount of curvature.

FIG. 25 shows a dashed line representation of FIG. 24.

FIGS. 20 and 21 (dashed line representation of FIG. 20) show a curvature progression KV along a longitudinal sectional contour LKA, analogous to FIGS. 5 and 6. The longitudinal sectional contour LKA extends through the bulged region 42 and the flattened region 40.

Here too, a clearly changed curvature progression is apparent compared to the curvature progression KV present in the corner region E in the bottom region according to the prior art shown in FIGS. 5 and 6. Here too, the curvature progression within the flattened region 40 assumes an (absolute) minimum within the corner region E formed by the bulged region 42 and the flattened region. Here too, the portion of the longitudinal sectional contour LKA which runs in the flattened region 40 is surrounded by an adjacent portion of the longitudinal sectional contour LKA (within the bulged region 42) in which the longitudinal sectional contour is curved in the same orientation (convex) and assumes in each case a greater curvature value and/or amount of curvature compared to the curvature values within the flattened region 40.

FIGS. 26-31 show representations, which are analogous to FIGS. 20-25, of curvature progressions of a bottom region 2 according to the invention according to a second embodiment, in which a trapezoid (in contrast to a triangle in the case of FIGS. 20-25) was used as a transverse contour for the construction.

In this case, FIGS. 26 and 27 (FIG. 27 is a dashed line representation of FIG. 26) show the curvature progression along a bottom line BL which runs through the supporting surface 23, but not through the flattened region 40 (and at the edge of the bulge progression 42).

When it is projected onto a plane running perpendicular to the central axis, the bottom line shown in the example has a circle diameter of 66 mm for the exemplary container described in the context of FIGS. 5-10 with the now modified bottom region according to the invention.

Here, the curvature progression is again similar to that from the prior art.

In this case, FIGS. 28 and 29 (FIG. 29 is a dashed line representation of FIG. 28) show the curvature progression along a bottom line BL which runs through the supporting region 24, not through the supporting surface 23. Furthermore, the bottom line BL runs through the flattened region 40 and through the bulge progression 42.

When it is projected onto a plane running perpendicular to the central axis, the bottom line shown in the example has a circle diameter of 77 mm for the exemplary container described in the context of FIGS. 5-10 with the now modified bottom region according to the invention.

In contrast, a curvature behavior KV of the bottom line BL that is changed compared to the prior art is present in the corner region E. During the transition from the supporting region 24 to the bulged region 42, an abrupt increase in the curvature value (and the amount of curvature) KV takes place, which then continuously decreases until the flattened region 40 has been reached. There is no curvature in the latter, which is why the curvature value is zero. After the portion of the bottom line BL running in the flattened region, the bottom line passes through a further portion of the bulged region 42, which in this case surrounds the full circumference of the flattened region 40. In this region, the bottom line is curved again, wherein the curvature has the same orientation as in the portion of the bulged region 42 between the flattened region 40 and the supporting region 24.

The bottom line BL shown in FIGS. 30 and 31 (FIG. 31 represents the dashed line representation of FIG. 30) runs outside of the bulged region and outside of the flattening progression and therefore has a curvature progression comparable to the prior art.

When it is projected onto a plane running perpendicular to the central axis, the bottom line shown in the example has a circle diameter of 64.50 mm for the exemplary container described in the context of FIGS. 5-10 with the now modified bottom region according to the invention.

FIG. 32 shows a use of a trapezoid with legs TS as a transverse contour, which is an alternative to using a triangle as a transverse contour, which trapezoid was used in the construction of the bottom regions according to FIGS. 26-31.

FIG. 33 shows the trapezoid used, which here has an opening angle of 130°, a preferred height of 15 mm, a preferred small side length of 5.0 mm.

Delimitation in radial and circumferential directions:

The flattenings are symmetrical at the foot, radially they are in a range between diameter of the bottom * 60% (D*60%) and diameter of the bottom * 90% (D*90%). And measured from the center of the foot from 2.5° to 22° to the right and to the left.

FIGS. 34-36 illustrate a preferred relative geometric position relative to the circumferential direction U of the flattened regions 40 with respect to the supporting region 24, the groove base 32 and the turning point region W together with the corresponding angle dimensions of a preferred embodiment.

FIG. 34 shows that the (preferably entire) flattened region 40 is arranged between 5° and 22°, measured (in the circumferential direction U) from the geometric center of the supporting surface 24.

FIG. 35 shows a radial position of the flattened region 40. In this case, the flattened region preferably lies in a range between 60% and 90% of the radius of the container and/or of the bottom region (half the bottom diameter) as viewed in the radial direction.

FIG. 36 illustrates that the turning points W of the curvature (in particular of the bottom lines BL) are not at 18°, but at 19° as considered from the left coming from the foot (geometric center of the supporting region) and 17° as considered coming from the tension band (in particular from the geometric center of the groove base 32 of the groove 30).

The surface between the tension band 5° and the foot angle 8.54° is preferably established via the auxiliary geometry of diameter*35%, diameter*70% and diameter*95%. In the example, the diameter is 100 mm.

FIG. 36 furthermore illustrates the supporting region circumferential angle designated with α_{SB} over which the supporting region 24 extends and which designates or defines the extension of the supporting region 24, the supporting foot circumferential angle designated with α_{F} over which a single supporting foot 22 extends, viewed in the circumferential direction, and the bulged region circumferential angle designated with α_{W} over which the region of the bulged region 42 arranged between the flattened region 40 and the supporting region 24 (as considered in the circumferential direction) extends.

W1 and W2 designate lines which define an angular segment in which the corresponding turning points WP (of a curvature progression along a bottom line) between the supporting foot 22 and the groove 30 or groove base 32 are arranged. As can be seen, this is very narrow, or only has an extension of 1° (in the circumferential direction).

FIGS. 37-39 show further three-dimensional representations of bottom regions according to preferred embodiments. Different bottom lines and their curvature progressions are shown.

FIG. 40 shows an illustration corresponding to FIGS. 34-36 for a bottom region from the prior art, as shown by FIGS. 5-10. Here too, the angular extension of a supporting foot is 19°, in the case of 5 supporting feet.

FIGS. 41-48 each show two bottom lines of a bottom region according to the present invention in a preferred embodiment compared to a bottom line of a corresponding bottom region from the prior art. The bottom lines are shown in FIG. 41 along the bottom region and also in a state that is unwound (along the cylinder lateral surface).

The bottom line BLS from the prior art is shown dotted.

FIG. 43 illustrates the bottom lines from FIG. 41 without a representation of the bottom region. The flattening of the bottom line BL1 compared to the corresponding bottom line BLS from the prior art in the corner region of the supporting feet is clearly apparent.

Here, BLS designates a bottom line with the same diameter as the pitch circle diameter (the pitch circle diameter here is 64.5 mm).

BLS designates the standard bottom according to the prior art without a flattening at 75 mm (circle diameter of the bottom line in its projection onto a plane running perpendicular to the central axis).

BL1 designates a bottom line of a bottom with a flattening at 75 mm (circle diameter of the bottom line in its projection onto a plane running perpendicular to the central axis).

FIG. 44 illustrates the unwinding of the bottom lines BL1, BL2, BLS from FIG. 41.

FIGS. 45, 49 and 50 illustrate, by the representation of sectional curves through the bottom region and the bottom lines, that a point of the bottom line of the bottom from the prior art is (unwound) 1.4 mm further away from the geometric center of the supporting foot and/or supporting region than a point of the bottom line located in the center of the flattened region, wherein the bottom region has the same tangent around the two points.

FIG. 50 shows radial sections to determine the angle.

FIG. 45 illustrates that, in the preferred example shown here of the previously described container, the height of the turning point is 9.6 mm.

Furthermore, the distance from the original bottom to the bottom with a flattening is 1.4 mm unwound on the diameter at 75 mm.

The horizontal distance of the original bottom to the bottom with a flattening is 0.9 mm, which corresponds to approximately 1.2°.

The vertical distance of the flattening to the height line of the turning point is 6.7 mm, and thus a ratio of about 6.7/9.6=0.69791666, 69.79%.

The vertical distance of the original bottom BLS from the height line of the turning point is 7.9 mm, is approximately 7.9/9.6=0.8229, 82.29%.

As described above, for this example of a container having a bottom region and/or container diameter 100 mm, with a pitch circle diameter 64.5 mm, the bottom clearance is 5.507 mm. The bottom clearance is measured from the contact surface to the injection point.

FIGS. 46-48 illustrate the progression of the height values of the different bottom lines BL1, BL2, and BLS from the previous figures. The height values here are plotted in the axis H (see also FIG. 48) directed upward in the figure plane. A designates a maximum difference of the height values of the bottom line in the region of the supporting region and the bottom line in the region of the groove base (maximum amplitude). The height axis H is preferably directed against the longitudinal direction L, but runs parallel to it.

The height values can, for example, each be measured as a distance of a point of the bottom line from a plane perpendicular on the central axis, which plane runs, for example, through the boundary region between the bottom region and the main body of the container and/or which is parallel to a supporting plane on which the container stands upright.

P designates a point on the bottom line in a portion within the flattened region 40. Point \tilde{P} denotes the corresponding point on the bottom line BLS of the bottom from the prior art, which has the same tangent as point P in the bottom line PL1.

FIGS. 47 and 48 illustrate the strong reduction, caused by the flattening, in the height value H of a bottom line running through the flattened region 40 compared to a bottom line from the prior art with the same diameter or the same distance from the central axis.

The axis directed upwards in the figure plane is the height axis H, on which the height values of the bottom lines are plotted. In this case, the corresponding turning point of the bottom line is used as a reference, i.e. the height values are measured here as a distance from a plane (running perpendicular to the central axis) which runs through the turning point of the corresponding bottom line between the supporting foot and the adjacent groove.

The axis directed to the right in the figure plane represents a progression of the circumferential angle α, measured from the geometric center of the supporting region. The curves shown correspond to the unwound bottom lines shown in FIG. 46. The reference sign MS designates the geometric center of the supporting region. The reference sign Hₛdesignates the height value of the geometric center of the supporting region MS.

α_{T/2} designates the angle between the geometric center of the supporting region and the geometric center of the adjacent groove and/or of the adjacent groove base MN.

ΔH designates the height difference of the height value of the point P and MS.

FIGS. 46-48 are not schematic representations but true-to-scale images.

FIGS. 51 and 52 here show a heat map representation of a surface curvature of the supporting foot in the region between the supporting region and the beginning of the groove base (true-to-scale image) for a bottom region according to the prior art (FIG. 51), as described and illustrated, for example, in FIG. 5-10, and for a bottom region 2 according to the invention according to the embodiment shown in FIGS. 20-25.

It can be clearly seen that the bottom shown in FIG. 52 with the flattened region 40 has a minimum surface curvature in the region of the flattened region 40 (in the entire region of the flattened region 40) (here the surface curvature is in each case zero). It can further be seen that this region is surrounded (completely) by a region with (at least) local maximum curvature value amounts or curvature values. This region represents the bulged region 42.

In contrast to this, in the supporting foot, maximum curvature values are not in a (circular) ring-like region, but in an, in particular circular or circle-like, region of maximum surface curvature values in which each shortest connecting line extending along the bottom region between two points of the region also runs within the region of maximum surface curvature values.

FIGS. 53-FIG. 60 show different preferred embodiments of a blow molding device 100 according to the invention, which here are designed to form a bottom region 2 of a plastic container 1. The blow molding device shown in FIGS. 53-FIG. 60 is a bottom part which is suitable and intended only for producing a bottom region and which has only an inner contour or inner surface corresponding to the outer surface of a bottom region of a plastic container to be produced. The blow molding device 100 can additionally (in each case) have two side parts for producing the main body or the side wall of the plastic container 1. The bottom part and the at least one side part or the two side parts can preferably be detachably connected to one another (preferably in pairs).

Each of the blow molding devices 100 shown here in FIGS. 53-60 has, in this case five, supporting foot forming regions 122 for the corresponding formation or production of a supporting foot 22 of a plastic container 1 to be produced.

Each supporting foot forming region has a supporting region 124 for forming a supporting region (explained above) of a supporting foot 22 of a plastic container 1 to be produced.

A flattened region 140 is arranged in each case next to the supporting region in and against the circumferential direction (relative to the central axis of the plastic container 1 to be produced), which flattened region is designed to correspond to the flattened region 40 described above (in particular according to a preferred embodiment).

FIGS. 53-60 show that, in the flattened region, preferably (exactly one) an opening for venting the blow molding device is arranged. The opening 130 arranged in the flattened region 140 preferably has a larger venting and/or flow cross-section than the further openings. This advantageously takes into account that this region of the supporting foot is not formed as quickly as the remaining regions of the supporting foot during the blow molding process of the container. A particularly high quality of the forming of the supporting foot region can thereby be achieved.

The openings 130 preferably have a diameter between 0.8 mm and 5 mm.

FIGS. 53-60 furthermore show that a bulged region 142 (which is more curved than the flattened region) is provided at least partially around the circumference of the flattened region 140 and is preferably designed to correspond to the bulged region 42 (in particular according to a preferred embodiment) described above. In the representations shown, the bulged region in each case completely surrounds the circumference of the corresponding flattened region 140 and particularly preferably adjoins the entire circumference thereof.

FIGS. 53 and 54 show two different perspective views of a blow molding device 100 in which an opening 132 is designed as a curved slot. This slot preferably opens into the opening arranged in the flattened region 140. A further opening is arranged in the portion of the bulged region 142 arranged closer to the bottom center compared to the flattened region.

FIG. 55 shows a blow molding device 100 with a plurality of openings 130 designed to be substantially circular in cross-section (for venting the blow molding device), which are preferably bores. The openings 100 are arranged along a (single) curved line 152 (in particular extending in the circumferential direction with respect to the central axis of the plastic container to be produced). The curvature of the line preferably increases with the radial distance from the central axis.

FIGS. 56 and 57 show two different perspective views of a blow molding device 100 with a plurality of openings 130 designed to be substantially circular in cross-section (for venting the blow molding device), which are preferably bores. The openings 100 are thereby arranged along a (single) line 153 running substantially within a plane and/or running rectilinearly. The plane or the rectilinear progression is preferably arranged obliquely with respect to the central axis, wherein the plane or the rectilinear progression of the line preferably extends along the circumferential direction. The plurality of openings 130 are preferably arranged in one row.

FIG. 58 shows a blow molding device 100 with a plurality of openings 130 designed to be substantially circular in cross-section (for venting the blow molding device), which are preferably bores. The openings 100 are arranged in two rows, each along a line 153 running substantially within a plane and/or running rectilinearly. The corresponding plane or the corresponding rectilinear progression is preferably arranged obliquely with respect to the central axis, wherein the plane or the rectilinear progression of the line extends along the circumferential direction. The two rows are preferably arranged substantially next to one another and/or substantially parallel to one another.

FIG. 59 shows a blow molding device 100 with a plurality of openings 130 designed to be substantially circular in cross-section (for venting the blow molding device), which are preferably bores. The openings 100 are arranged in two rows, each along a curved line 152 (extending in particular in the circumferential direction with respect to the central axis of the plastic container to be produced). The curvature of the corresponding line preferably increases with the radial distance from the central axis. The two rows are preferably arranged substantially next to one another and/or substantially parallel to one another.

FIG. 60 shows a blow molding device 100 with a plurality of openings 130 designed to be substantially circular in cross-section (for venting the blow molding device), which are preferably bores. The openings 100 are arranged in three rows, each along a line 153 running substantially within a plane and/or running rectilinearly. The corresponding plane or the corresponding rectilinear progression is preferably arranged obliquely with respect to the central axis, wherein the plane or the rectilinear progression of the line extends along the circumferential direction. The three rows are preferably arranged substantially next to one another and/or substantially parallel to one another.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

### LIST OF REFERENCE SIGNS

1 plastic container
2 bottom region
4 main body
6 mouth region
8 container mouth
18 injection point, bottom center
19 geometric center of the bottom wall, bottom center
22 supporting foot
23 supporting surface
24 supporting region
26 foot side region
27 foot lower region
28 foot outer region
30 groove
32 groove base
40 flattened region
42 bulged region
100 blow molding device
122 supporting foot forming area
124 supporting region
130 opening
132 slot-shaped opening
140 flattened region
142 bulged region
152 curved progression
132 rectilinear, oblique progression
A maximum height difference of the bottom line
BK edge
BF “book surface”
E corner region
L longitudinal direction
LK longitudinal sectional contour
LA flattened region delimitation line
LKA longitudinal sectional contour through flattened region
M central axis
MS geometric center of supporting region
K circle
KV curvature progression
DS leg
W turning point region
α_{SB} supporting region circumferential angle
α_{F} supporting foot circumferential angle
α_{W} bulged region circumferential angle
α_{T/2} bulged region circumferential angle

1. A plastic container, having a bottom region, a main body adjoining this bottom region in the longitudinal direction of the plastic container, and a mouth region adjoining this main body at least indirectly in the longitudinal direction and having a container mouth, wherein the bottom region has at least three supporting feet, wherein each of these supporting feet has at least one supporting region extending in the circumferential direction with respect to the longitudinal direction over a supporting region circumferential angle and each having at least one supporting surface for standing the plastic container upright, wherein at least one groove having a groove base acting as a tension band is arranged between two of these supporting feet, said groove base widening outwardly in the radial direction of the plastic container, wherein the at least three supporting feet are delimited in the circumferential direction by at least one foot side region in each case and in a radial direction toward the outside by a foot outer region,
wherein
the at least three supporting feet in a corner region of the supporting feet, in which the supporting region, the foot side region and the foot outer region meet, have at least one flattened region which causes a flattening of the corresponding supporting foot in the corner region.

2. A plastic container, having a bottom region, a main body adjoining this bottom region in the longitudinal direction of the plastic container, and a mouth region adjoining this main body at least indirectly in the longitudinal direction and having a container mouth, wherein the bottom region has at least three supporting feet which, viewed in the circumferential direction with respect to a central axis of the bottom region extending along the longitudinal direction, each extend over a supporting foot circumferential angle, wherein each of these supporting feet has at least one supporting region extending in the circumferential direction over a supporting region circumferential angle and each having at least one supporting surface for standing the plastic container upright, wherein at least one groove having a groove base acting as a tension band is arranged between two of these supporting feet, the groove base widening outwardly in the radial direction,
wherein
each of the at least three supporting feet has at least one flattened region arranged at least partially between the supporting region and the adjacent groove and at least one bulged region arranged between the flattened region and the supporting region, wherein the flattened region is flattened compared to the bulged region with respect to a curvature behavior, wherein the bulged region extends, as viewed in the circumferential direction, at most over half the supporting region circumferential angle and/or at most over one tenth of the supporting foot circumferential angle.

3. A plastic container having a bottom region, a main body adjoining this bottom region in the longitudinal direction of the plastic container, and a mouth region adjoining this main body at least indirectly in the longitudinal direction and having a container mouth, wherein the bottom region has at least three supporting feet, wherein each of these supporting feet has at least one supporting region extending in the circumferential direction with respect to a central axis of the bottom region extending along the longitudinal direction and each having at least one supporting surface for standing the plastic container upright, wherein at least one groove having a groove base acting as a tension band is arranged between two of these supporting feet, the groove base widening outwardly in the radial direction,
wherein
the bottom region is configured such that a bottom line running along the bottom region from a geometric center of the supporting region of a supporting foot to the groove base of the adjacent groove at a constant distance from the central axis has a geometric progression of height values, considered along the central axis, as a function of an angle of rotation measured in the circumferential direction with respect to the geometric center of the supporting region, which angle of rotation, after passing through the supporting region, decreases sharply in such a way that a maximum height value assumed in the supporting region within a line portion, which takes up at most 30% of an angle of rotation between the geometric center of the supporting region and the geometric center of the groove base of the adjacent groove, is reduced by at least 8% with respect to a maximum height difference of the bottom line.

4. The plastic container according to claim 1,
wherein
the bottom region is configured such that a bottom line running along the bottom region from a geometric center of the supporting region of a supporting foot over a turning point region, in which an orientation of the curvature of the bottom region changes, to the groove base of the adjacent groove at a constant distance from the central axis has a geometric progression of height values, considered along the central axis, as a function of an angle of rotation measured in the circumferential direction with respect to the geometric center of the supporting region, which angle of rotation decreases strongly in a region adjoining the supporting region such that a maximum height value assumed in the supporting region within a line portion of the base line, which takes up at least 30% of an angle of rotation between the geometric center of the supporting region and the geometric center of the groove base of the adjacent groove, is reduced by at least 15% with respect to a height difference of the base line to the height value assumed in the turning point region.

5. The plastic container according to claim 1,
wherein
a bulged region with a curvature progression of the same orientation adjoins in each case the flattened region of the supporting foot, viewed both in the direction of the adjacent groove and/or of the groove base of the adjacent groove and viewed in the direction of the supporting region of the supporting foot, wherein the amount of the curvature within the bulged regions assumes at least one maximum with respect to the curvature amounts assumed within the flattened region.

6. The plastic container according to claim 5,
wherein
the bulged region surrounds at least substantially half the circumference of the flattened region.

7. The plastic container according to claim 6,
wherein
the amount of the surface curvature within the entire flattened region is smaller than the amount of the surface curvature of the bulged region surrounding at least half the circumference of the flattened region.

8. The plastic container according to claim 1,
wherein
a cross-sectional contour formed by a longitudinal section through the bottom region, the longitudinal sectional plane of which runs through the flattened region of a supporting foot and through the central axis of the plastic container, has a curvature progression which assumes a local minimum in the flattened region compared to the surrounding portions.

9. The plastic container according to claim 1,
wherein
the flattened region tapers in the direction of the groove base.

10. The plastic container according to claim 1,
wherein
the flattened region is substantially flat.

11. The plastic container according to claim 1,
wherein
the flattened region has a surface area which amounts to at least one quarter of the supporting surface of the supporting region of the supporting foot for standing the plastic container upright.

12. The plastic container according to claim 1,
wherein
the at least three supporting feet each have two flattened regions which, in cross-section, follow the progression of the legs of a triangle at least in portions.

13. The plastic container according to claim 12,
wherein
a distance between a tip of the triangle and the supporting foot is between 0 and 20 mm.

14. The plastic container according to claim 12,
wherein
an opening angle of the triangle which encloses the tip of the triangle is between 45° and 170°.

15. The plastic container according to claim 1,
wherein
the flattened region follows a substantially parabolic progression.

16. The plastic container according to claim 1,
wherein
the supporting foot has at least two flattened regions and the two flattened regions and the supporting region of the supporting foot follow a progression of an open trapezoid in cross-section at least in portions.

17. The plastic container according to claim 1,
wherein
the foot side regions of the supporting foot are configured in portions as foot flank surfaces formed by a free-form surface.

18. A blow molding device for the production of plastic containers having an inner wall, against which a plastic container can be expanded during a blow molding process,
wherein
the inner wall has a contour that is configured for creating a plastic container according to claim 1.

19. The blow molding device according to claim 18,
wherein
the blow molding device has at least one supporting foot forming region for producing a supporting foot of the plastic container, wherein the inner wall of the blow molding device has at least one flattened region in the region of the supporting foot forming region.

20. The blow molding device according to claim 19,
wherein
each supporting foot forming region of the blow molding device configured to form a supporting foot has at least one opening, wherein the at least one opening is arranged at least in regions in the flattened region of the blow mold.
